(19) United States
(12) Patent Application Publication
(10) Pub. No.: US 2026/0038428 A1
(43) Pub. Date: Feb. 5, 2026

(54) ELECTRONIC DEVICE COMPRISING DISPLAY COMPRISING SUBPIXELS EACH COMPRISING AT LEAST TWO LEDS

(71) Applicant: Samsung Electronics Co., Ltd., Suwon-si (KR)

(72) Inventors: Yongkoo HER, Suwon-si (KR); Kiwoo KIM, Suwon-si (KR); Seoungyong PARK, Suwon-si (KR); Hongkook LEE, Suwon-si (KR); Euntaek JANG, Suwon-si (KR)

(21) Appl. No.: 19/351,544

(22) Filed: Oct. 7, 2025

Related U.S. Application Data
(63) Continuation of application No. PCT/KR2024/003525, filed on Mar. 20, 2024.

(30) Foreign Application Priority Data
May 15, 2023 (KR) 10-2023-0062367
Jun. 5, 2023 (KR) 10-2023-0072330

(51) Int. Cl. G09G 3/32

(52) U.S. Cl. CPC G09G 3/32; G09G 2320/0233; G09G 2330/10

(57) ABSTRACT

An electronic device is provided. The electronic device includes display driving circuitry, and a display panel, wherein a subpixel in the display panel includes a plurality of light-emitting diodes (LEDs) comprising a first LED and a second LED, a driving transistor including a first gate electrode configured to obtain a data voltage, a first drain, and a first source electrode, a first light-emitting control transistor comprising a second gate electrode, a second source electrode connected to the first drain, and a second drain electrode connected to an anode of the first LED among the plurality of LEDs. a second emission control transistor including a third gate electrode, a third source electrode connected to the first drain, and a third drain electrode connected to an anode electrode of the second LED among the plurality of LEDs.

### CROSS-REFERENCE TO RELATED APPLICATION(S)

This application is a continuation application, claiming priority under 35 U.S.C. § 365 (c), of an International application No. PCT/KR2024/003525, filed on Mar. 20, 2024, which is based on and claims the benefit of a Korean patent application number 10-2023-0062367, filed on May 15, 2023, in the Korean Intellectual Property Office, and of a Korean patent application number 10-2023-0072330, filed on Jun. 5, 2023, in the Korean Intellectual Property Office, the disclosure of each of which is incorporated by reference herein in its entirety.

### BACKGROUND

### 1. Field

The disclosure relates to an electronic device including a display including sub-pixels each including two or more light emitting diodes (LEDs).

### 2. Description of Related Art

An electronic device may include a display panel. For example, the display panel may include a plurality of light emitting elements. For example, the electronic device may display an image on the display panel by emitting at least a portion of the plurality of light emitting elements. For example, each of the plurality of light emitting elements may be a micro light emitting diode (micro-LED) having a width of less than 100 micrometers.

The above information is presented as background information only to assist with an understanding of the disclosure. No determination has been made and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a display including sub-pixels each including two or more LEDs.

Additional aspects will be set forth in part in the description which follows and, in part, will be apparent from the description, or may be learned by practice of the presented embodiments.

In accordance with an aspect of the disclosure, an electronic device is provided. The electronic device includes display driver circuitry and a display panel, wherein a sub-pixel in the display panel includes a plurality of light emitting diodes (LEDs) including a first LED and a second LED, a driving transistor including a first gate electrode configured to obtain a data voltage, a drain electrode, and a first source electrode, a first emission control transistor including a second gate electrode, a second source electrode connected to the first drain electrode, and a second drain electrode connected to an anode electrode of the first LED from among the LEDs, a second emission control transistor including a third gate electrode, a third source electrode connected to the first drain electrode, and a third drain electrode connected to an anode electrode of the second LED from among the LEDs, wherein the display driver circuitry is configured to, in a first emission interval in a time interval corresponding to a refresh rate, provide a first emission signal to the second gate electrode to provide, using the driving transistor, a current according to the data voltage to the first LED from among the LEDs, and in a second emission interval in the time interval subsequent to the first emission interval, provide a second emission signal to the third gate electrode to provide, using the driving transistor, the current to the second LED from among the LEDs.

In accordance with another aspect of the disclosure, an electronic device is provided. The electronic device includes a display panel including sub-pixels, wherein each of the sub-pixels includes a driving transistor including a gate electrode configured to obtain a data voltage, a source electrode configured to obtain a driving voltage, and a drain electrode, and a plurality of light emitting diodes (LEDs) including a first LED including a first anode electrode connected to a node connectable to the drain electrode, and a first cathode, a second LED including a second anode electrode connected to the first cathode, and a second cathode, a third LED including a third anode electrode connected to the node and disconnected from the first cathode, and a third cathode, and a fourth LED including a fourth anode electrode connected to the third cathode and disconnected from the first cathode, and a fourth cathode.

In accordance with another aspect of the disclosure, an electronic device is provided. The electronic device includes a display panel including sub-pixels, wherein each of the sub-pixels includes a driving transistor including a gate electrode configured to obtain a data voltage, a source electrode configured to obtain a driving voltage, and a drain electrode, and a plurality of light emitting diodes (LEDs) including a first LED including a first anode electrode connected to a node connectable to the drain electrode, and a first cathode, a second LED including a second anode electrode connected to the first cathode, and a second cathode, a third LED including a third anode electrode connected to the node and disconnected from the first cathode, and a third cathode connected to the first cathode and connected to the second anode electrode, and a fourth LED including a fourth anode electrode connected to the third cathode, connected to the first cathode, and connected to the second anode electrode, and a fourth cathode.

In accordance with another aspect of the disclosure, an electronic device is provided. The electronic device includes a display panel including sub-pixels. Each of the sub-pixels includes a driving transistor including a gate electrode configured to obtain a data voltage, a source electrode configured to obtain a driving voltage, and a drain electrode. Each of the sub-pixels includes a plurality of light emitting diodes (LEDs) including a first LED including a first anode electrode connected to a node connectable to the drain electrode and a first cathode, a second LED including a second anode electrode connected to the first cathode and a second cathode, and a third LED including a third anode electrode connected to the first cathode and disconnected from the second cathode and a third cathode.

In accordance with another aspect of the disclosure, an electronic device is provided. The electronic device includes a display panel including sub-pixels. Each of the sub-pixels includes a driving transistor including a gate electrode configured to obtain a data voltage, a source electrode configured to obtain a driving voltage, and a drain electrode. Each of the sub-pixels includes a plurality of light emitting diodes (LEDs) including a first LED including a first anode electrode connected to a node connectable to the drain electrode and a first cathode, a second LED including a second anode electrode connected to the first cathode and a second cathode, and a third LED including a third anode electrode connected to the node and disconnected from the first cathode, and a third cathode connected to the first cathode and connected to the second anode electrode.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a simplified block diagram of an electronic device according to an embodiment of the disclosure;

FIG. 2 illustrates a display panel of an electronic device according to an embodiment of the disclosure;

FIG. 3 illustrates a sub-pixel in a display panel of an electronic device according to an embodiment of the disclosure;

FIG. 4 illustrates a method of controlling a sub-pixel in a display panel according to an embodiment of the disclosure;

FIG. 5 is a chart illustrating a relationship between a current provided to an LED and efficiency of the LED according to an embodiment of the disclosure;

FIG. 6 illustrates a method of controlling a sub-pixel including an LED having a manufacturing fault according to an embodiment of the disclosure;

FIG. 7 illustrates a method of controlling a sub-pixel including an LED having a manufacturing fault based on a compensation of a data voltage according to an embodiment of the disclosure;

FIGS. 8 and 9 illustrate an example of a sub-pixel including two or more emission control transistors according to various embodiments of the disclosure;

FIG. 10 illustrates an example of a first mode and a second mode provided through a display panel according to an embodiment of the disclosure;

FIG. 11 illustrates an example of a sub-pixel and another sub-pixel sharing an LED according to an embodiment of the disclosure;

FIG. 12 illustrates an example of a switch used for sharing an LED according to an embodiment of the disclosure;

FIGS. 13, 14A, and 14B illustrate an method of controlling a sub-pixel and another sub-pixel sharing an LED according to various embodiments of the disclosure;

FIG. 15 illustrates a method of compensating for a luminance of a periphery region of a display panel according to an embodiment of the disclosure;

FIG. 16 illustrates a method of providing a mode for a luminance greater than or equal to a reference luminance using a display panel according to an embodiment of the disclosure;

FIGS. 17, 18, 19, and 20 illustrate a sub-pixel in a display panel of an electronic device including three or more LEDs according to various embodiments of the disclosure;

FIG. 21 is a block diagram of an electronic device in a network environment according to an embodiment of the disclosure; and

FIG. 22 is a block diagram of a display module according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

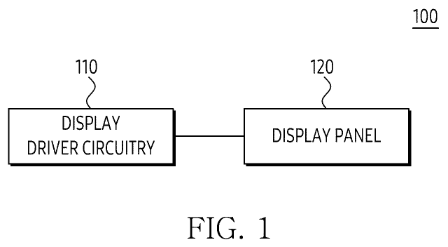

FIG. 1 is a simplified block diagram of an electronic device according to an embodiment of the disclosure.

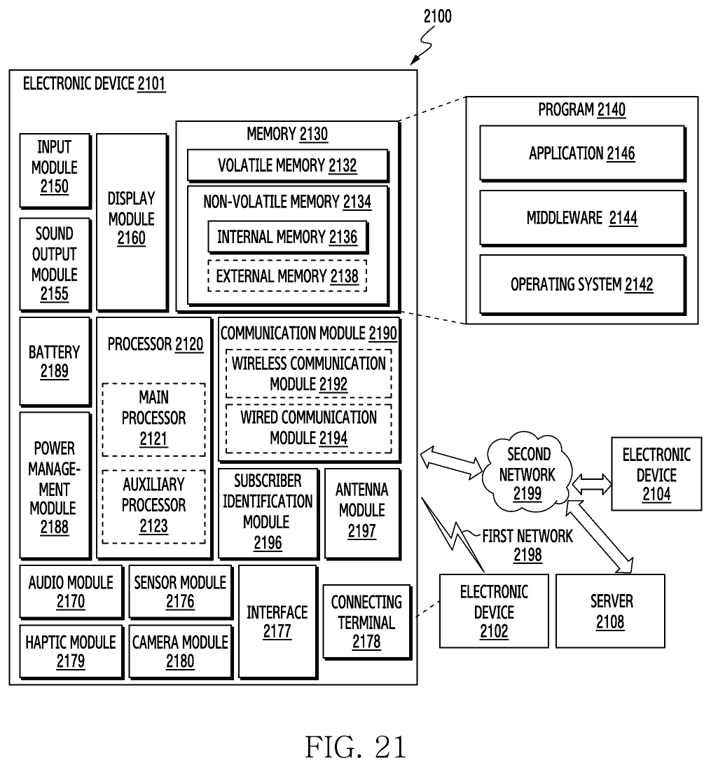

Referring to FIG. 1, an electronic device 100 may be one of various types of mobile devices such as a smartphone, a tablet, a wearable device, a cellular phone, and other similar computing devices. Components illustrated in FIG. 1, their relationships, and their functions are merely exemplary and do not limit the implementations described or claimed in this document. The electronic device 100 may be referred to as a user device, a multifunctional device, or a portable device. The electronic device 100 may include at least a portion of the electronic device 2101 of FIG. 21. The electronic device 100 may be a display module (or display) included in one of the above-described devices.

The electronic device 100 may include components including display driver circuitry 110 and a display panel 120. The above components are merely exemplary. For example, the electronic device 100 may include another component (e.g., at least a portion of the processor 2120 of FIG. 21).

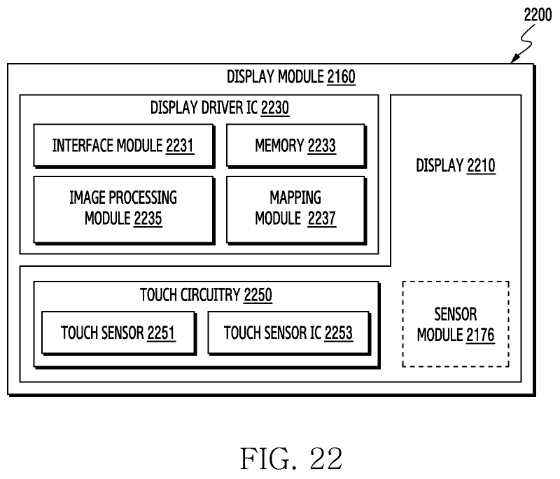

The display driver circuitry 110 may be used to display an image received from a processor of the electronic device 100 (e.g., the processor 2120 of FIG. 21) (or a processor of an external electronic device) on the display panel 120. For example, the display driver circuitry 110 may include at least a portion of the DDI 2230 of FIG. 22 or may correspond to at least a portion of the DDI 2230.

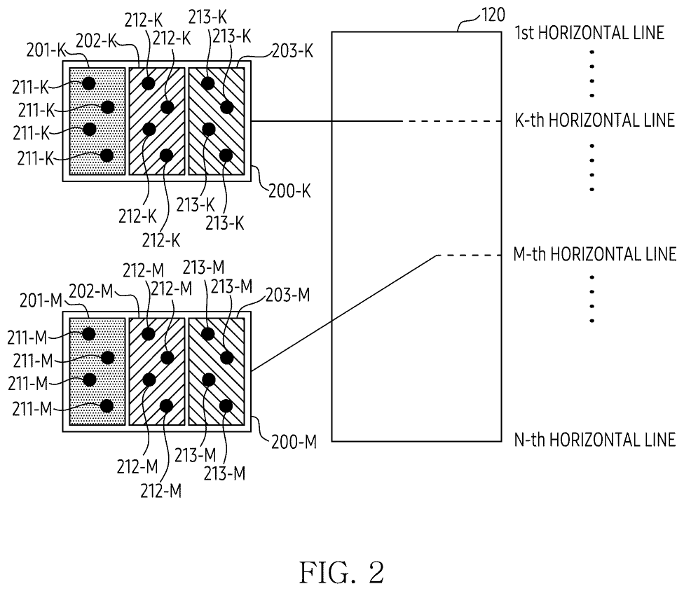

The display panel 120 may be used to display an image based on controlling of the display driver circuitry 110. For example, the display panel 120 may include pixels for the displaying of the image. For example, each of the pixels may include sub-pixels. For example, the sub-pixels may be used to emit red light, green light, blue light, and/or white light. As a non-limiting example, a width of each of the sub-pixels may be in a range of about 50 micrometers to about 90 micrometers. For example, each of the sub-pixels may include a plurality of light emitting diodes (LEDs). As a non-limiting example, each of the plurality of LEDs may be a micro-LED. Each of the sub-pixels may be exemplified in the description of FIG. 2.

FIG. 2 illustrates a display panel of an electronic device according to an embodiment of the disclosure.

Referring to FIG. 2, the display panel 120 may include pixels positioned along a plurality of horizontal lines. For example, the number of the plurality of horizontal lines may be N (N is a natural number greater than 1). For example, each of the pixels may include sub-pixels.

For example, a pixel 200-K in a K-th horizontal line (K is a natural number greater than or equal to 1 and less than or equal to N) from among the plurality of horizontal lines may include a sub-pixel 201-K for emitting red light, a sub-pixel 202-K for emitting green light, and a sub-pixel 203-K for emitting blue light. Unlike the illustration of FIG. 2, a portion of the sub-pixels exemplified above may be excluded from the pixel 200-K. Unlike the illustration of FIG. 2, the pixel 200-K may further include at least one sub-pixel. For example, the at least one sub-pixel may be used to emit red light, green light, blue light, or white light.

For example, a pixel 200-M in the M-th horizontal line (M is a natural number greater than or equal to 1 and less than or equal to N, and is different from K) from among the plurality of horizontal lines may include a sub-pixel 201-M for emitting red light, a sub-pixel 202-M for emitting green light, and a sub-pixel 203-M for emitting blue light. Unlike the illustration of FIG. 2, a portion of the sub-pixels exemplified above may be excluded from the pixel 200-M. Unlike the illustration of FIG. 2, the pixel 200-M may further include at least one sub-pixel. For example, the at least one sub-pixel may be used to emit red light, green light, blue light, or white light.

For example, each of sub-pixels in each of the pixels in the display panel 120 may include two or more LEDs. For example, each of the two or more LEDs may be a micro-LED. For example, each of the two or more LEDs may be referred to as a redundant LED (or redundancy LED). For example, remaining LEDs except for one of the two or more LEDs may be referred to as the redundant LED.

For example, in the pixel 200-K, the sub-pixel 201-K may include a plurality of LEDs 211-K, the sub-pixel 202-K may include a plurality of LEDs 212-K, and the sub-pixel 203-K may include a plurality of LEDs 213-K. As a non-limiting example, the number of the plurality of LEDs 211-K may be different from the number of the plurality of LEDs 212-K. As a non-limiting example, the number of the plurality of LEDs 211-K may be different from the number of the plurality of LEDs 213-K. As a non-limiting example, the number of the plurality of LEDs 212-K may be different from the number of the plurality of LEDs 213-K.

For example, the number of each of the plurality of LEDs 211-K, the plurality of LEDs 212-K, and the plurality of LEDs 213-K may be 2 to 3, unlike the illustration of FIG. 2. The number of each of the plurality of LEDs 211-K, the plurality of LEDs 212-K, and the plurality of LEDs 213-K may be a natural number greater than 4, unlike the illustration of FIG. 2.

For example, in the pixel 200-M, the sub-pixel 201-M may include a plurality of LEDs 211-M, the sub-pixel 202-M may include a plurality of LEDs 212-M, and the sub-pixel 203-M may include a plurality of LEDs 213-M. As a non-limiting example, the number of the plurality of LEDs 211-M may be different from the number of the plurality of LEDs 212-M. As a non-limiting example, the number of the plurality of LEDs 211-M may be different from the number of the plurality of LEDs 213-M. As a non-limiting example, the number of the plurality of LEDs 212-M may be different from the number of the plurality of LEDs 213-M.

For example, the number of each of the plurality of LEDs 211-M, the plurality of LEDs 212-M, and the plurality of LEDs 213-M may be 2 to 3, unlike the illustration of FIG. 2. The number of each of the plurality of LEDs 211-M, the plurality of LEDs 212-M, and the plurality of LEDs 213-M may be a natural number greater than 4, unlike the illustration of FIG. 2.

For example, the number of the plurality of LEDs 211-K may be different from the number of the plurality of LEDs 211-M, unlike the illustration of FIG. 2. For example, the number of the plurality of LEDs 212-K may be different from the number of the plurality of LEDs 212-M, unlike the illustration of FIG. 2. For example, the number of the plurality of LEDs 213-K may be different from the number of the plurality of LEDs 213-M, unlike the illustration of FIG. 2.

Referring back to FIG. 1, the plurality of LEDs included in the sub-pixel may be emitted within different emission intervals (or emission period or emission cycle). For example, a time interval (e.g., 1/60 (second)) corresponding to a refresh rate (e.g., 60 hertz (Hz)) for displaying of an image may include a plurality of emission intervals. As a non-limiting example, lengths of the plurality of emission intervals may be the same.

For example, a first LED from among the plurality of LEDs may be emitted within a first emission interval within the time interval, and a second LED from among the plurality of LEDs may be emitted within a second emission interval within the time interval. For example, the second emission interval may be subsequent to the first emission interval. For example, the first LED may begin emitting at a timing within the first emission interval according to a position of the sub-pixel, and the second LED may begin emitting at a timing within the second emission interval according to the position of the sub-pixel. For example, the first LED may begin emitting at the timing within the first emission interval according to a position of a horizontal line including the sub-pixel, and the second LED may begin emitting at the timing within the second emission interval according to the position of the horizontal line.

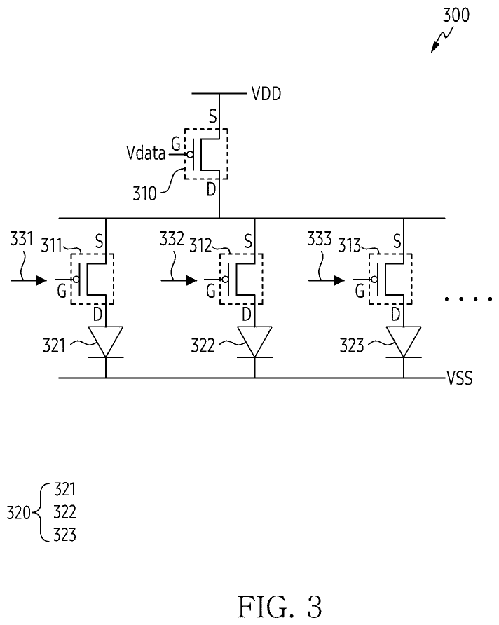

For example, the sub-pixel may include components for emitting the first LED within the first emission interval and emitting the second LED within the second emission interval. The components may be exemplified in the description of FIG. 3.

FIG. 3 illustrates a sub-pixel in a display panel of an electronic device according to an embodiment of the disclosure.

Referring to FIG. 3, a sub-pixel 300 may include a driving transistor 310, a first emission control transistor 311, a second emission control transistor 312, and a plurality of LEDs 320 including a first LED and a second LED. For example, the plurality of LEDs 320 may include a first LED 321 and a second LED 322.

For example, the driving transistor 310 may be used to provide a current for emitting at least a portion of the plurality of LEDs 320. For example, the driving transistor 310 may include a first gate electrode configured to obtain a data voltage (e.g., Vdata), a first source electrode configured to obtain a driving voltage (e.g., VDD), and a first drain electrode.

For example, the first emission control transistor 311 may include a second gate electrode, a second source electrode connected to the first drain electrode, and a second drain electrode connected to an anode electrode of the first LED 321 from among the plurality of LEDs 320. For example, the second emission control transistor 312 may include a third gate electrode, a third source electrode connected to the first drain electrode, and a third drain electrode connected to an anode electrode of the second LED 322 from among the plurality of LEDs 320.

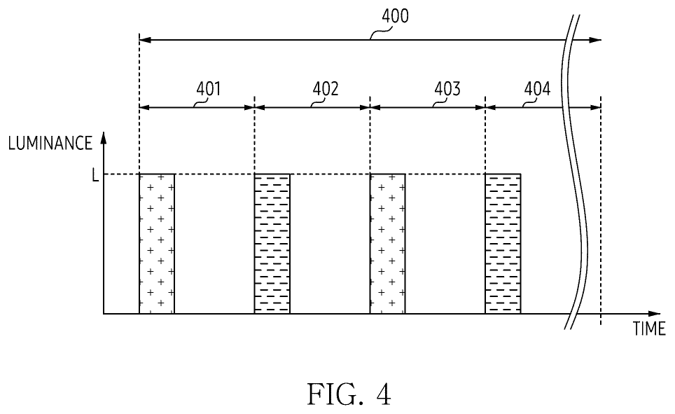

For example, the first LED 321 from among the plurality of LEDs 320 may be emitted within the first emission interval based on a current provided through the driving transistor 310 according to the data voltage and a first emission signal 331 provided to the second gate electrode, and the second LED 322 from among the plurality of LEDs 320 may be emitted within the second emission interval based on the current and a second emission signal 332 provided to the third gate electrode. The emission of the first LED 321 within the first emission interval and the emission of the second LED 322 within the second emission interval may be exemplified in the descriptions of FIGS. 3 and 4.

FIG. 4 illustrates a method of controlling a sub-pixel in a display panel according to an embodiment of the disclosure.

Referring to FIG. 4, a time interval 400 corresponding to a refresh rate may include a plurality of emission intervals. For example, the time interval 400 may include a first emission interval 401, a second emission interval 402 subsequent to the first emission interval 401, a third emission interval 403 subsequent to the second emission interval 402, and a fourth emission interval 404 subsequent to the third emission interval 403.

FIG. 4 illustrates an example in which the second emission interval 402 is immediately after the first emission interval 401, but the time interval 400 may further include an emission interval between the first emission interval 401 and the second emission interval 402.

Referring further to FIG. 3, the display driver circuitry 110 may apply, to the first gate electrode, a data voltage for displaying of an image within the time interval 400.

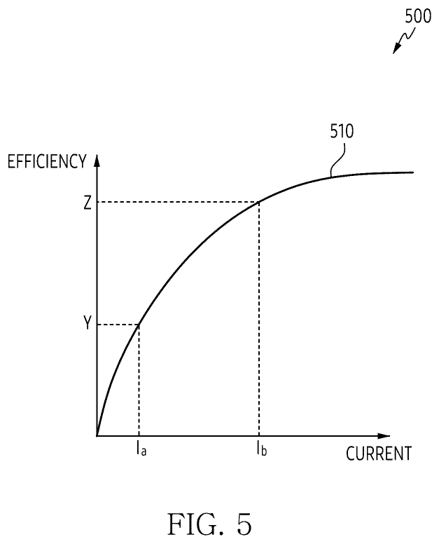

For example, the display driver circuitry 110 may provide, to the second gate electrode, a first emission signal 331 to provide a current according to the data voltage to the first LED 321 from among the plurality of LEDs 320 by using the driving transistor 310, within the first emission interval 401 within the time interval 400. For example, the first LED 321 from among the plurality of LEDs 320 may be emitted at a luminance L corresponding to the current for displaying of the image, in response to the first emission signal 331. Due to a characteristic of each of the first LED 321 and the second LED 322, emitting the first LED 321 within the first emission interval 401 to provide the luminance L may be more efficient than simultaneously emitting both the first LED 321 and the second LED 322 within the first emission interval 401 to provide the luminance L. The characteristic of each of the first LED 321 and the second LED 322 may be exemplified in the description of FIG. 5.

FIG. 5 is a chart illustrating a relationship between a current provided to an LED and efficiency of the LED according to an embodiment of the disclosure.

Referring to FIG. 5, a horizontal axis of a chart 500 indicates a current provided to an LED (e.g., the first LED 321 or the second LED 322), a vertical axis of the chart 500 indicates efficiency (unit: cd/A) of the LED, and a line 510 in the chart 500 indicates a relationship between the current and the efficiency.

For example, as indicated by the line 510, when a current provided to the LED is Ia, efficiency (or emission efficiency) of the LED may be Y, and when a current provided to the LED is Ib higher than Ia, efficiency of the LED may be K higher than Y. For example, when obtaining a higher current, the LED may have a higher efficiency.

Referring back to FIG. 4, a current provided to the first LED 321 from among the first LED 321 and the second LED 322 for providing a luminance L by using the first LED 321 from among the first LED 321 and the second LED 322 within the first emission interval 401 may be higher than a current provided to each of the first LED 321 and the second LED 322 for providing the luminance L by using both the first LED 321 and the second LED 322 within the first emission interval 401. Since each of the first LED 321 and the second LED 322 has higher efficiency (e.g., emission efficiency or current efficiency) when obtaining a higher current, emitting only the first LED 321 within the first emission interval 401 for providing a luminance L may be more efficient than emitting both the first LED 321 and the second LED 322 within the first emission interval 401 for providing the luminance L. For example, the electronic device 100 may display an image with enhanced efficiency by emitting one of the plurality of LEDs 320 within the sub-pixel 300, based on the higher current.

For example, the display driver circuitry 110 may provide, to the third gate electrode, a second emission signal 332 to provide the current to the second LED 322 from among the plurality of LEDs 320 by using the driving transistor 310 within the second emission interval 402 within the time interval 400. For example, the second LED 322 from among the plurality of LEDs 320 may be emitted at a luminance L, in response to the second emission signal 332. Emitting only the second LED 322 within the second emission interval 402 for providing the luminance L may be more efficient than emitting both the first LED 321 and the second LED 322 within the second emission interval 402 for providing the luminance L. For example, the electronic device 100 may display an image with enhanced efficiency by emitting one of the plurality of LEDs 320 within the sub-pixel 300 based on a higher current.

For example, the display driver circuitry 110 may provide, to the second gate electrode, a first emission signal 331 to provide the current to the first LED 321 from among the plurality of LEDs 320 by using the driving transistor 310 within the third emission interval 403 within the time interval 400. For example, the first LED 321 from among the plurality of LEDs 320 may be emitted at a luminance L, in response to the first emission signal 331.

For example, the display driver circuitry 110 may provide, to the third gate electrode, a second emission signal 332 to provide the current to the second LED 322 from among the plurality of LEDs 320 by using the driving transistor 310 within the fourth emission interval 404 within the time interval 400. For example, the second LED 321 from among the plurality of LEDs 320 may be emitted at a luminance L, in response to the second emission signal 332.

Although FIG. 4 illustrates an example in which the first LED 321 is emitted within each of the first emission interval 401 and the third emission interval 403 and the second LED 322 is emitted within each of the second emission interval 402 and the fourth emission interval 404, the display driver circuitry 110 may also provide the first emission signal 321 and the second emission signal 322 so that the first LED 321 is emitted within the first emission interval 401 and the second emission interval 402 and the second LED 322 is emitted within the third emission interval 403 and the fourth emission interval 404.

Referring back to FIG. 3, the plurality of LEDs 320 within the sub-pixel 300 may further include a third LED 323. For example, the third LED 323 from among the plurality of LEDs 320 may have a manufacturing fault (or manufacturing defect, manufacturing flaw, or manufacturing error) or may not have the manufacturing fault. As a non-limiting example, the third LED 323 having a manufacturing fault may indicate that the third LED 323 is shorted. As a non-limiting example, the third LED 323 having a manufacturing fault may indicate that the third LED 323 is open-circuited (or opened). As a non-limiting example, the third LED 323 having a manufacturing fault may indicate that the third LED 323 is misaligned (or aligned incorrectly).

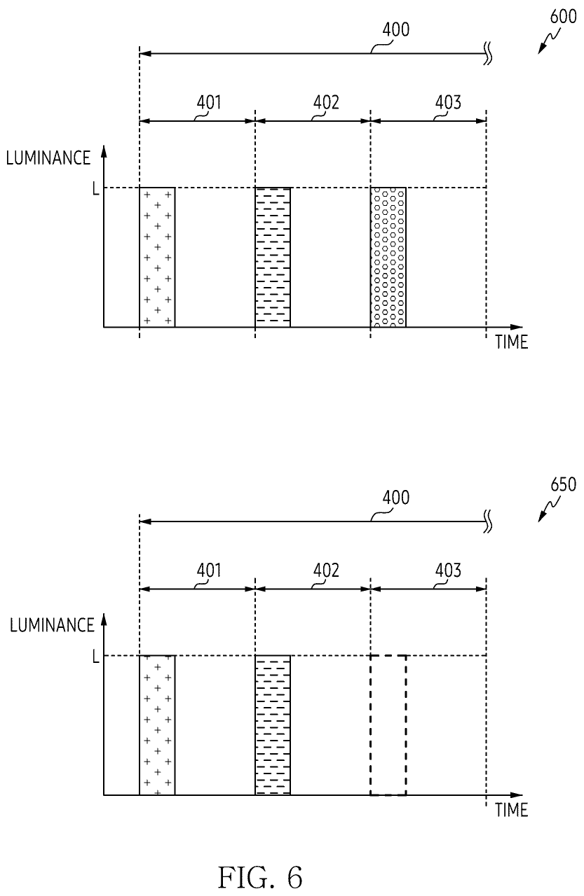

For example, the sub-pixel 300 may further include a third emission control transistor 313. The third emission control transistor 313 may include a fourth gate electrode, a fourth source electrode connected to the first drain electrode, and a fourth drain electrode connected to an anode electrode of the third LED 323 from among the plurality of LEDs 320. For example, the third LED 323 from among the plurality of LEDs 320 may be emitted or may not be emitted within a third emission interval subsequent to the second emission interval, based on the current provided through the driving transistor 310 and a third emission signal 333 provided to the fourth gate electrode, according to the presence or absence of a manufacturing fault. For example, control of the sub-pixel 300 may vary according to whether the third LED 323 has a manufacturing fault. The control may be exemplified in the descriptions of FIGS. 3 and 6.

FIG. 6 illustrates a method of controlling a sub-pixel including an LED having a manufacturing fault according to an embodiment of the disclosure.

Referring further to FIG. 6, as indicated by the state 600, when the third LED 323 does not have a manufacturing fault, the display driver circuitry 110 may provide, to the fourth gate electrode, a third emission signal 333 to provide the current according to the data voltage to the third LED 323 from among the plurality of LEDs 320 by using the driving transistor 310, within the third emission interval 403 within the time interval 400. For example, in response to the third emission signal 333, the third LED 323 from among the plurality of LEDs 320 may be emitted at a luminance L corresponding to the current for the displaying of the image.

For example, as indicated by the state 650, when the third LED 323 has a manufacturing fault, the display driver circuitry 110 may forgo or bypass providing the third emission signal 333 to the fourth gate electrode within the third emission interval 403. For example, the display driver circuitry 110 may forgo providing the third emission signal 333 to forgo emitting the third LED 323 within the third emission interval 403.

As a non-limiting example, it is assumed that the sub-pixel 300 includes only a single emission control transistor connected to (connected in parallel with) each of the plurality of LEDs 320, and that the third LED 323 from among the plurality of LEDs 320 is shorted. In the sub-pixel 300, a current provided through the driving transistor 310 may only be provided to the shorted third LED 323. For example, since the current is not provided to remaining LEDs (e.g., the first LED 321 and the second LED 322) not having a manufacturing fault due to the shorted third LED 323, the sub-pixel 300 may be dead due to the shorted third LED 323.

For example, unlike the assumption, since the sub-pixel 300 includes a plurality of emission control circuits (e.g., the first emission control transistor 311, the second emission control transistor 312, and the third emission control transistor 313) each connected to the plurality of LEDs 320 (e.g., the first LED 321, the second LED 322, and the third LED 323), the sub-pixel 300 may provide light using another portion of the plurality of LEDs 320 even when a portion of the plurality of LEDs 320 are shorted.

As a non-limiting example, although not illustrated in FIG. 6, when the third LED 323 has a manufacturing fault, the display driver circuitry 110 may emit, instead of the third LED 323, one LED different from the third LED 323 from among the plurality of LEDs 320 within the third emission interval 403. For example, when the third LED 323 has a manufacturing fault, the display driver circuitry 110 may provide, to the second gate electrode, a first emission signal 331 to provide the current according to the data voltage to the first LED 321 from among the plurality of LEDs 320 by using the driving transistor 310, within the third emission interval 403. For another example, when the third LED 323 has a manufacturing fault, the display driver circuitry 110 may provide, to the third gate electrode, a second emission signal 332 to provide the current according to the data voltage to the second LED 322 from among the plurality of LEDs 320 by using the driving transistor 310, within the third emission interval 403.

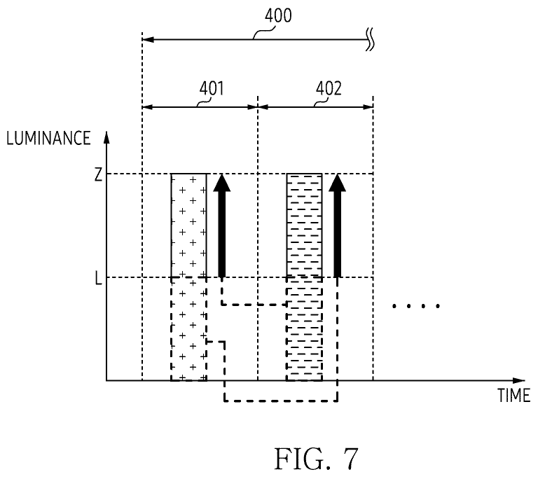

As a non-limiting example, although not illustrated in FIG. 6, when the third LED 323 has a manufacturing fault, the display driver circuitry 110 may forgo or bypass emission within the third emission interval 403 and increase a data voltage provided to the first gate electrode. For example, when the first LED 321, the second LED 322, and the third LED 323 all do not have a manufacturing fault, the display driver circuitry 110 may apply, to the first gate electrode, another data voltage higher than the data voltage provided to the first gate electrode, within time interval 400. For example, the display driver circuitry 110 may compensate for the forgoing (or bypassing) of emission within the third emission interval 403, by providing another current according to the other data voltage to the first LED 321 within the first emission interval 401 and providing the other current to the second LED 322 within the second emission interval 402 using the driving transistor 310. The compensation will be exemplified in the description of FIG. 7.

As a non-limiting example, unlike the above examples, one of the first LED 321 and the second LED 322 within the sub-pixel 300 may have a manufacturing fault. For example, when the first LED 321 has a manufacturing fault, the display driver circuitry 110 may forgo emitting the first LED 321 within the first emission interval 401 and emit the second LED 322 within the second emission interval 402. For example, the display driver circuitry 110 may compensate for providing light only within the second emission interval 402 from among the first emission interval 401 and the second emission interval 402, by using an increase in the data voltage. For another example, when the second LED 322 has a manufacturing fault, the display driver circuitry 110 may emit the first LED 321 within the first emission interval 401 and forgo emitting the second LED 322 within the second emission interval 402. For example, the display driver circuitry 110 may compensate for providing light only within the first emission interval 401 from among the first emission interval 401 and the second emission interval 402, by using an increase in the data voltage. These operations may be exemplified in the description of FIG. 7.

FIG. 7 illustrates a method of controlling a sub-pixel including an LED having a manufacturing fault based on a compensation of a data voltage according to an embodiment of the disclosure.

Referring further to FIG. 7, when the first LED 321 has a manufacturing fault, the display driver circuitry 110 may forgo emitting the first LED 321 within the first emission interval 401 and emit the second LED 322 within the second emission interval 402. For example, the second LED 322 emitted within the second emission interval 402 may provide a luminance Z higher than a luminance L provided within each of the first emission intervals 401 and the second emission interval 402 when both the first LED 321 and the second LED 322 do not have a manufacturing fault. For example, instead of forgoing emitting the first LED 321 within the first emission interval 401, the display driver circuitry 110 may apply, to the gate electrode of the driving transistor 310, another data voltage higher than a data voltage provided to the first gate electrode, when both the first LED 321 and the second LED 322 do not have a manufacturing fault. For example, the display driver circuitry 110 may provide a second emission signal 332 to the third gate electrode to apply another current (e.g., a current about twice the current corresponding to the data voltage) according to the other data voltage to the second LED 322 within the second emission interval 402. For example, the second LED 322 may be emitted within the second emission interval 402 to provide a luminance Z corresponding to the other current, in response to the second emission signal 332. For example, the display driver circuitry 110 may compensate for a manufacturing fault of the first LED 321 by changing (or increasing) a data voltage applied to the first gate electrode.

For example, when the second LED 322 has a manufacturing fault, the display driver circuitry 110 may emit the first LED 321 within the first emission interval 401 and forgo emitting the second LED 322 within the second emission interval 402. For example, the first LED 321 emitted within the first emission interval 401 may provide a luminance Z higher than a luminance L provided within each of the first emission interval 401 and the second emission interval 402 when both the first LED 321 and the second LED 322 do not have a manufacturing fault. For example, instead of forgoing emitting the second LED 322 within the second emission interval 402, the display driver circuitry 110 may apply, to the gate electrode of the driving transistor 310, another data voltage higher than a data voltage provided to the first gate electrode when both the first LED 321 and the second LED 322 do not have a manufacturing fault. For example, the display driver circuitry 110 may provide a first emission signal 331 to the second gate electrode to provide another current according to the other data voltage to the first LED 321 within the first emission interval 401. For example, the first LED 321 may be emitted to provide the luminance Z corresponding to the other current within the first emission interval 401, in response to the first emission signal 331. For example, the display driver circuitry 110 may compensate for a manufacturing fault of the second LED 322 by changing (or increasing) a data voltage provided to the first gate electrode.

As a non-limiting example, although not illustrated in FIG. 7, when the first LED 321 has a manufacturing fault, the display driver circuitry 110 may emit the second LED 322 within both the first emission interval 401 and the second emission interval 402 instead of changing a data voltage to control the second LED 322 to emit light within the second emission interval 402 from among the first emission interval 401 and the second emission interval 402. For example, the display driver circuitry 110 may provide, to the third gate electrode, a second emission signal 332 to provide, by using the driving transistor 310, a current corresponding to the luminance L to the second LED 322 within both the first emission interval 401 and the second emission interval 402.

As a non-limiting example, although not illustrated in FIG. 7, when the second LED 322 has a manufacturing fault, the display driver circuitry 110 may emit the first LED 321 within both the first emission interval 401 and the second emission interval 402 instead of changing a data voltage to control the first LED 321 to emit light within the first emission interval 401 from among the first emission interval 401 and the second emission interval 402. For example, the display driver circuitry 110 may provide, to the second gate electrode, a first emission signal 331 to provide, by using the driving transistor 310, a current corresponding to the luminance L to the first LED 321 within both the first emission interval 401 and the second emission interval 402.

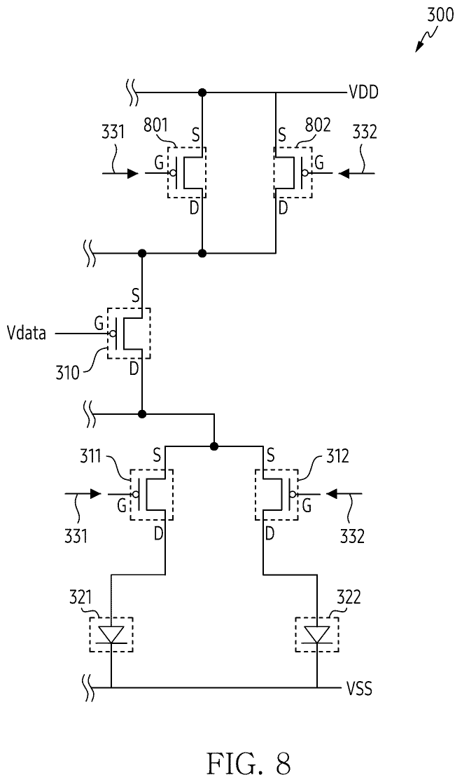

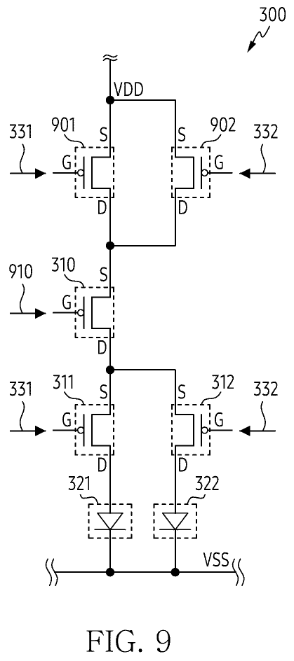

Referring back to FIG. 3, the sub-pixel 300 may be implemented in various ways. The example of the sub-pixel 300 may be exemplified in the descriptions of FIGS. 8 and 9.

FIGS. 8 and 9 illustrate an example of a sub-pixel including two or more emission control transistors according to various embodiments of the disclosure.

Referring to FIG. 8, the sub-pixel 300 may further include a first operation control transistor 801 and a second operation control transistor 802. For example, the first operation control transistor 801 may include a fourth source electrode configured to obtain a driving voltage (e.g., VDD), a fourth gate electrode, and a fourth drain electrode connected to the first source electrode of the driving transistor 310. For example, the second operation control transistor 802 may include a fifth source electrode configured to obtain a driving voltage (e.g., VDD), a fifth gate electrode, and a fifth drain electrode connected to the first source electrode of the driving transistor 310. For example, the display driver circuitry 110 may provide a first emission signal 331 to the fourth gate electrode within a first emission interval 401 and a second emission signal 332 to the fifth gate electrode within a second emission interval 402.

Referring to FIG. 9, the sub-pixel 300 may provide light based on a pulse width modulation (PWM) technique (or control or driving). For example, the sub-pixel 300 may further include a first operation control transistor 901 and a second operation control transistor 902. For example, the first operation control transistor 901 may include a fourth source electrode configured to obtain a driving voltage (e.g., VDD), a fourth gate electrode, and a fourth drain electrode connected to the first source electrode of the driving transistor 310. For example, the second operation control transistor 902 may include a fifth source electrode configured to obtain a driving voltage (e.g., VDD), a fifth gate electrode, and a fifth drain electrode connected to the first source electrode of the driving transistor 310. For example, unlike the driving transistor 310 within the sub-pixel 300 of FIGS. 3 and 8, the driving transistor 310 within the sub-pixel 300 of FIG. 9 may be configured to obtain one or more pulse signals through the first gate electrode. For example, the display driver circuitry 110 may emit the first LED 321, based on providing the first emission signal 331 to the second gate electrode and the fourth gate electrode within the first emission interval 401. For example, the first LED 321 emitted within the first emission interval 401 may provide a luminance according to a width of each of the one or more pulse signals. For example, the display driver circuitry 110 may emit the second LED 322 based on providing the second emission signal 332 to the third gate electrode and the fifth gate electrode within the second emission interval 402. For example, the second LED 322 emitted within the second emission interval 402 may provide the luminance.

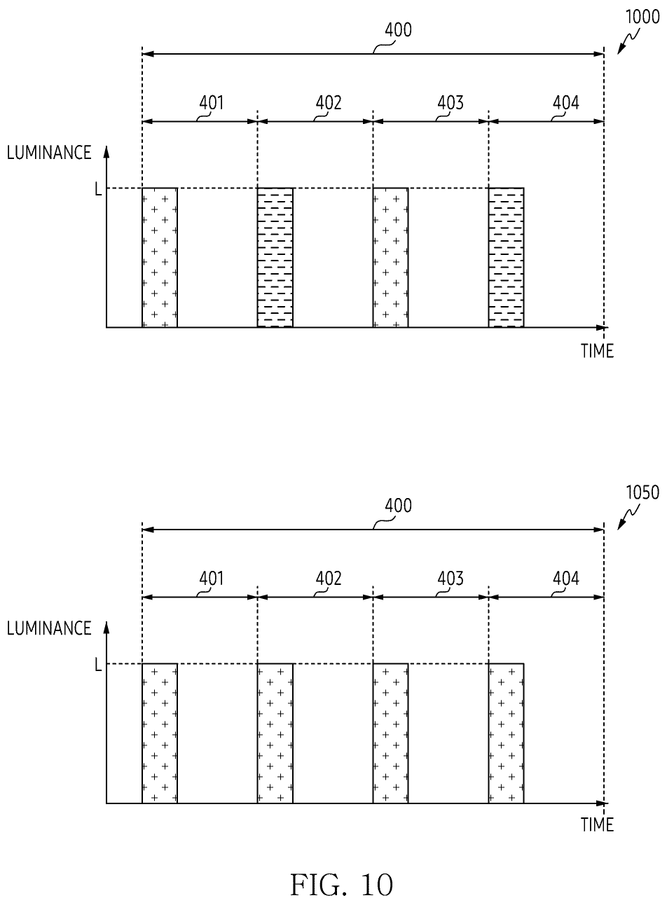

Referring back to FIG. 3, the display driver circuitry 110 may control the sub-pixels 300 differently according to a mode of the electronic device 100. For example, the mode may include a first mode and a second mode. For example, the second mode may indicate a mode in which an image is displayed on the display panel 120 at a lower power than a power consumed by displaying the image on the display panel 120 based on the first mode. For example, power consumed for the second mode may be lower than power consumed for the first mode. For example, the first mode may be referred to as a normal mode, and the second mode may be referred to as a low-power mode. For example, controlling of the sub-pixel 300 executed by the display driver circuitry 110 for the first mode and controlling of the sub-pixel 300 executed by the display driver circuitry 110 for the second mode may be exemplified in the description of FIG. 10.

FIG. 10 illustrates an example of a first mode and a second mode provided through a display panel according to an embodiment of the disclosure.

Referring to FIG. 10, as indicated by a state 1000, for the first mode, the display driver circuitry 110 may provide a first emission signal 331 to the second gate electrode to control the first LED 321 to emit light within a first emission interval 401, provide a second emission signal 332 to the third gate electrode to control the second LED 322 to emit light within a second emission interval 402, provide the first emission signal 331 to the second gate electrode to control the first LED 321 to emit light within a third emission interval 403, and provide the second emission signal 332 to the third gate electrode to control the second LED 322 to emit light within a fourth emission interval 404.

For example, as indicated by a state 1050, for the second mode, the display driver circuitry 110 may provide a first emission signal 331 to the second gate electrode to control the first LED 331 to emit light within each of the first emission interval 401, the second emission interval 402, the third emission interval 403, and the fourth emission interval 404. For example, the number of LEDs used for the first mode may be greater than the number of LEDs used for the second mode. For example, the electronic device 100 may provide the second mode by reducing the number of LEDs used for emission.

Alternatively, the display driver circuitry 110 may, for the second mode, forgo executing emission within a portion of emission intervals within the time interval 400. For example, for the second mode, the display driver circuitry 110 may emit the first LED 331 within each of the first emission interval 401 and the third emission interval 403 and may forgo or bypass executing emission within each of the second emission interval 402 and the fourth emission interval 404. For example, for the second mode, the display driver circuitry 110 may emit the second LED 332 within each of the second emission interval 402 and the fourth emission interval 404 and may forgo or bypass executing emission within each of the first emission interval 401 and the third emission interval 403.

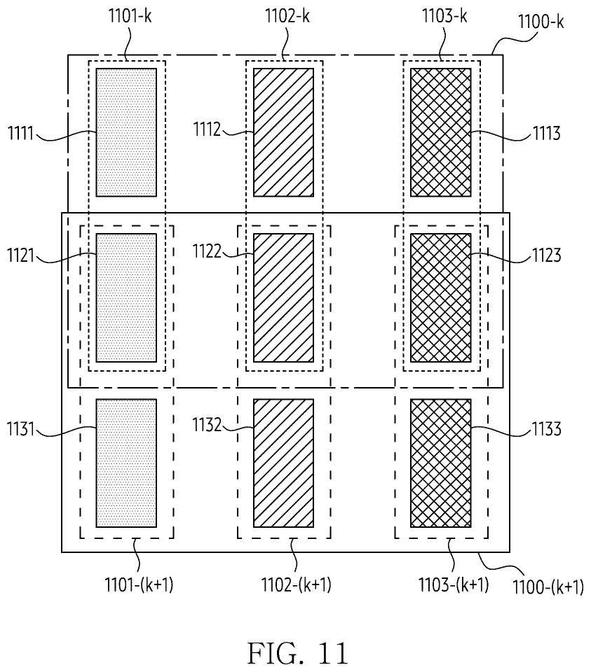

Referring back to FIG. 1, a sub-pixel and another sub-pixel in the display panel 120 may share one or more LEDs. The sub-pixel and the other sub-pixel that share the one or more LEDs may be exemplified in the description of FIG. 11.

FIG. 11 illustrates an example of a sub-pixel and another sub-pixel sharing an LED according to an embodiment of the disclosure.

Referring to FIG. 11, the display panel 120 may include a plurality of pixels. For example, the number of pixels may be N (N is a natural number greater than 2). For example, a pixel 1100-K in a K-th horizontal line (K is a natural number greater than or equal to 1 and less than or equal to N-1) of the plurality of pixels may include a sub-pixel 1101-K, a sub-pixel 1102-K, and a sub-pixel 1103-K. For example, a pixel 1100-(K+1) in a K+1th horizontal line among the plurality of pixels may include a sub-pixel 1101-(K+1), a sub-pixel 1102-(K+1), and a sub-pixel 1103-(K+1).

For example, the sub-pixel 1101-K may include a first LED 1111 and a second LED 1121 shared with the sub-pixel 1101-(K+1). For example, the sub-pixel 1101-(K+1) may include the second LED 1121 and a third LED 1131 shared with the sub-pixel 1101-K. For example, the sub-pixel 1102-K may include a first LED 1112 and a second LED 1122 shared with the sub-pixel 1102-(K+1). For example, the sub-pixel 1102-(K+1) may include the second LED 1122 and a third LED 1132 shared with the sub-pixel 1102-K. For example, the sub-pixel 1103-K may include a first LED 1113 and a second LED 1123 shared with the sub-pixel 1103-(K+1). For example, the sub-pixel 1103-(K+1) may include the second LED 1123 and a third LED 1133 shared with the sub-pixel 1103-K.

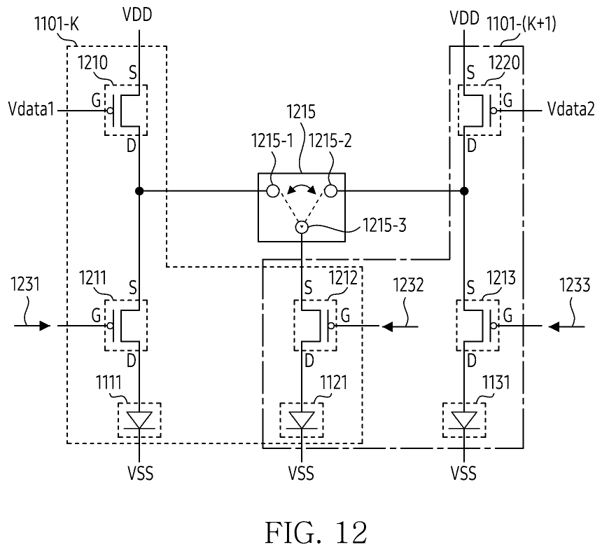

For example, the sub-pixel 1101-K and the sub-pixel 1101-(K+1) may share an emission control transistor connected to the second LED 1121, the sub-pixel 1102-K and the sub-pixel 1102-(K+1) may share an emission control transistor connected to the second LED 1122, and the sub-pixel 1103-K and the sub-pixel 1103-(K+1) may share an emission control transistor connected to the second LED 1123. Although not illustrated in FIG. 11, the display panel 110 may include a switch for controlling emitting the second LED 1121 for the sub-pixel 1101-K and emitting the second LED 1121 for the sub-pixel 1101-(K+1), a switch for controlling emitting the second LED 1122 for the sub-pixel 1102-K and emitting the second LED 1122 for the sub-pixel 1102-(K+1), and a switch for controlling emitting the second LED 1123 for the sub-pixel 1103-K and emitting the second LED 1123 for the sub-pixel 1103-(K+1). The emission control transistor shared by the sub-pixel 1101-K and the sub-pixel 1101-(K+1) and the switch for controlling emitting the second LED 1121 for the sub-pixel 1101-K and emitting the second LED 1121 for the sub-pixel 1101-(K+1) may be exemplified in the description of FIG. 12.

FIG. 12 illustrates an example of a switch used for sharing an LED according to an embodiment of the disclosure.

Referring to FIG. 12, a sub-pixel 1101-K may include a driving transistor 1210, a first emission control transistor 1211, a second emission control transistor 1212, a first LED 1111, and a second LED 1121. The sub-pixel 1101-(K+1) may include a driving transistor 1220, a third light emission control transistor 1213, a second LED 1121, and a third LED 1131.

For example, the driving transistor 1210 may include a first gate electrode configured to obtain a first data voltage (e.g., Vdata1), a first source electrode configured to obtain a driving voltage (e.g., VDD), and a first drain electrode connected to a second source electrode of the first emission control transistor 1211 and connected to a first terminal 1215-1 of a switch 1215. For example, the first emission control transistor 1211 may include a second gate electrode configured to obtain a first emission signal 1231, the second source electrode connected to the first drain electrode and connected to the first terminal 1215-1 of the switch 1215, and a second drain electrode connected to an anode electrode of the first LED 1111. For example, the second emission control transistor 1212 may include a third gate electrode configured to obtain a second emission signal 1232, a third source electrode connected to a third terminal 1215-3 of the switch 1215, and a third drain electrode connected to an anode electrode of the second LED 1121.

For example, the driving transistor 1220 may include a fourth gate electrode configured to obtain a second data voltage (e.g., Vdata2), a fourth source electrode configured to obtain a driving voltage (e.g., VDD), and a fourth drain electrode connected to a fifth source electrode of a third emission control transistor 1213 and a second terminal 1215-2 of the switch 1215. For example, the third emission control transistor 1213 may include a fifth gate electrode configured to obtain a third emission signal 1233, a fifth source electrode connected to the fourth drain electrode of the driving transistor 1220 and connected to the second terminal 1215-2 of the switch 1215, and a fifth drain electrode connected to an anode electrode of the third LED 1131.

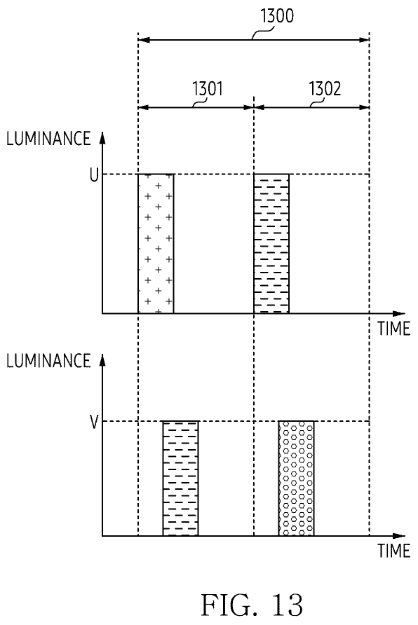

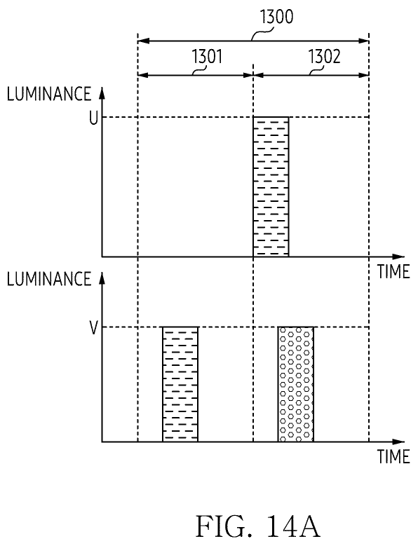

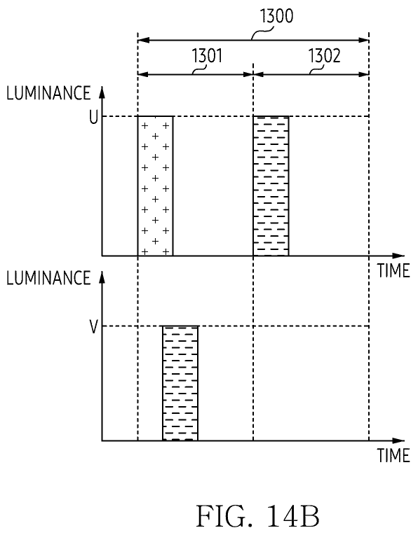

For example, the display driver circuitry 110 may emit the second LED 1121 for the sub-pixel 1101-K or emit the second LED 1121 for the sub-pixel 1101-(K+1), based on controlling of the switch 1215. For example, when the first LED 1111 or the third LED 1131 has a manufacturing fault, the display driver circuitry 110 may emit the second LED 1121 for the sub-pixel 1101-K or emit the second LED 1121 for the sub-pixel 1101-(K+1), based on controlling of the switch 1215. The controlling of the switch 1215 may be exemplified in the descriptions of FIGS. 13, 14A, and 14B.

FIGS. 13, 14A, and 14B illustrate a method of controlling a sub-pixel and another sub-pixel sharing an LED according to various embodiments of the disclosure.

Referring to FIG. 13, a time interval 1300 corresponding to a refresh rate may include a first emission interval 1301 and a second emission interval 1302.

For example, the display driver circuitry 110 may provide a first emission signal 1231 to the second gate electrode based on a timing according to a position of the sub-pixel 1101-K, in order to provide a first current according to the first data voltage to the first LED 1111 using the driving transistor 1210, within the first emission interval 1301. For example, the first LED 1111 may be emitted according to the first current, in response to the first emission signal 1231. For example, the first LED 1111 may be emitted within the first emission interval 1301 to provide a luminance U corresponding to the first current.

For example, the display driver circuitry 110 may control the switch 1215 to connect the second terminal 1215-2 to the third terminal 1215-3, in order to provide a second current according to the second data voltage to the second LED 1121 using the driving transistor 1220, within the first emission interval 1301. For example, the control may be executed based on a second control signal provided to the switch 1215 from the display driver circuitry 110. For example, the display driver circuitry 110 may provide, to the third gate electrode, a second emission signal 1232 based on a timing according to a position of the sub-pixel 1101-(K+1) while the second terminal 1215-2 is connected to the third terminal 1215-3, in order to provide the second current to the second LED 1121 using the driving transistor 1220, within the first emission interval 1301. For example, the second LED 1121 may be emitted within the first emission interval 1301 to provide a luminance V corresponding to the second current.

For example, since the position of the sub-pixel 1101-(K+1) is different from the position of the sub-pixel 1101-K, the second emission signal 1232 may be provided within the first emission interval 1301 after the first emission signal 1231 is provided.

For example, the display driver circuitry 110 may control the switch 1215 to connect the first terminal 1215-1 to the third terminal 1215-3 after completing the provision of the second emission signal 1232 within the first emission interval 1301. For example, the control may be executed before the second emission signal 1232 is provided to the third gate electrode within the second emission interval 1302.

For example, the display driver circuitry 110 may control the switch 1215 to connect the first terminal 1215-1 to the third terminal 1215-3, in order to provide the first current to the second LED 1121 using the driving transistor 1210, within the second emission interval 1302. For example, the control may be executed based on a first control signal provided to the switch 1215 from the display driver circuitry 110. For example, the display driver circuitry 110 may provide, to the third gate electrode, a second emission signal 1232 based on the timing according to the position of the sub-pixel 1101-K while the first terminal 1215-1 is connected to the third terminal 1215-3, in order to provide the first current to the second LED 1121 using the driving transistor 1210, within the second emission interval 1302. For example, the second LED 1121 may be emitted within the second emission interval 1302 to provide a luminance U corresponding to the first current.

For example, the display driver circuitry 110 may provide, to the fifth gate electrode, a third emission signal 1233 based on a timing according to the position of the sub-pixel 1101-(K+1), in order to provide the second current to the third LED 1131 using the driving transistor 1220, within the second emission interval 1302. For example, the third LED 1131 may be emitted within the second emission interval 1302 to provide a luminance V corresponding to the second current.

For example, since the position of the sub-pixel 1101-(K+1) is different from the position of the sub-pixel (1101-K), the third emission signal 1233 may be provided within the second emission interval 1302 after the second emission signal 1232 is provided.

As described above, the electronic device 100 may reduce the number of LEDs included in the display panel 120 through one or more LEDs shared by two sub-pixels.

When the first LED 1111 has a manufacturing fault unlike the second LED 1121 and the third LED 1131, the display driver circuitry 110 may execute operations that are partially different from the operations exemplified in the description of FIG. 13.

For example, referring to FIG. 14A, the display driver circuitry 110 may forgo or bypass emitting the first LED 1111 within the first emission interval 1301.

Although not illustrated in FIG. 14A, the display driver circuitry 110 may also emit the second LED 1121 within the second emission interval 1302 to provide a luminance higher than the luminance U by using the operations exemplified in FIG. 7. However, it is not limited thereto.

When the third LED 1131 has a manufacturing fault unlike the first LED 1111 and the second LED 1121, the display driver circuitry 110 may execute operations that are partially different from the operations exemplified in the description of FIG. 13.

For example, referring to FIG. 14B, the display driver circuitry 110 may forgo or bypass emitting the third LED 1131 within the second emission interval 1302.

Although not illustrated in FIG. 14B, the display driver circuitry 110 may also emit the second LED 1121 within the first emission interval 1301 to provide a luminance higher than the luminance V by using the operations exemplified in FIG. 7. However, it is not limited thereto.

Referring back to FIG. 1, a quality of displaying on a partial region of the display panel 120 may be lower than a quality of displaying on another partial region of the display panel 120. For example, current leakage may be caused from at least a portion of LEDs in the display panel 120 by light from outside. For example, the current leakage may reduce a luminance provided based on emitting the at least a portion of the LEDs. As a non-limiting example, the current leakage may be caused for providing a relatively high luminance through the display panel 120. As another example, due to an error during metal etching for the display panel 120, a color deviation may occur on the display panel 120. As another example, when the electronic device 100 is an AR glass or a video see through (VST) device, a luminance provided through a periphery region of the display panel 120 may be lower than a luminance provided through a center region of the display panel 120 according to an optical characteristic.

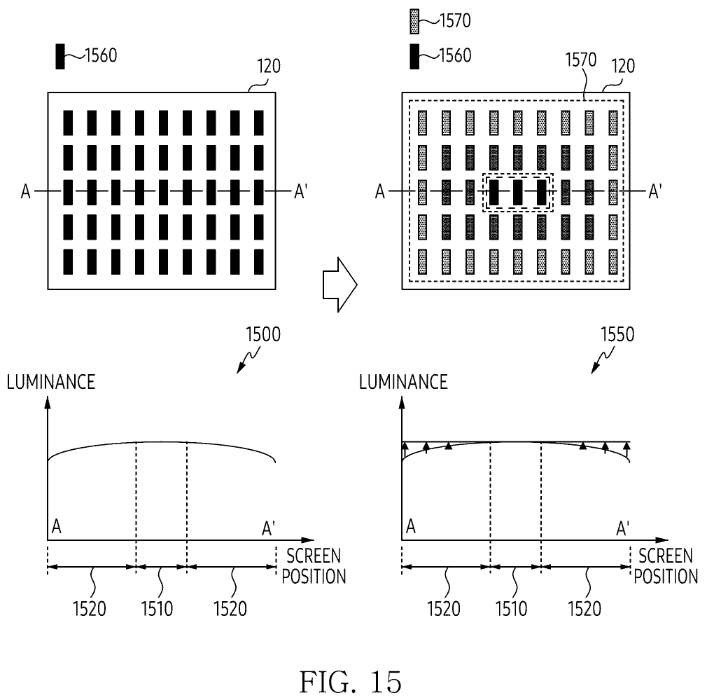

For example, the electronic device 100 may utilize LEDs within the display panel 120 to compensate for a luminance difference on the display panel 120. For example, the compensation may be executed by the display driver circuitry 110. The compensation may be exemplified in the description of FIG. 15.

FIG. 15 illustrates a method of compensating for a luminance of a periphery region of a display panel according to an embodiment of the disclosure.

Referring to FIG. 15, the display panel 120 may include a plurality of LEDs. For example, the plurality of LEDs may include a first set of LEDs with a manufacturing defect and a second set of LEDs without a manufacturing defect. Each of the plurality of LEDs, which is a micro-LED, may have a relatively small size, so a relatively large number of the second set of LEDs 1560 may be included to compensate for a decrease in a quality of an image displayed on the display panel 120 due to the first set of LEDs. Since the number of the second set of LEDs 1560 may be relatively large, a portion 1570 of the second set of LEDs 1560 may be used to compensate for a luminance of the display panel 120.

For example, as indicated by a chart 1500, a luminance of a periphery region 1520 of the display panel 120 may be lower than a luminance of a center region 1510 of the display panel 120. For example, the display driver circuitry 120 may emit the portion 1570 of the second set of LEDs 1560 to compensate for the luminance of the periphery region 1520 lower than the luminance of the center region 1510. For example, as indicated by a chart 1550, the display driver circuitry 120 may reduce a difference between the luminance of the center region 1510 and the luminance of the periphery region 1520, based on emitting the portion 1570 of the second set of LEDs 1560.

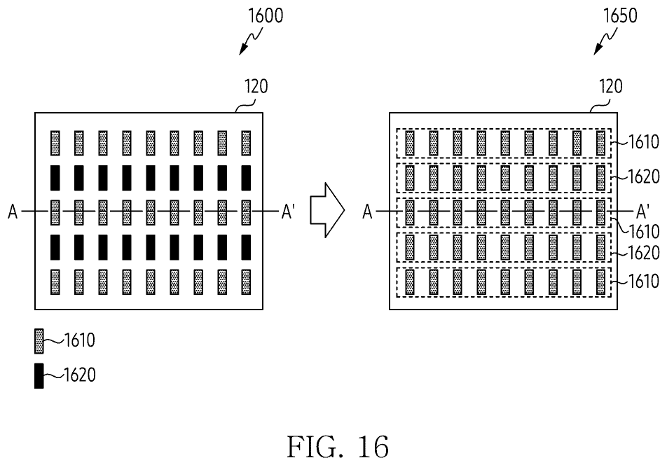

Referring back to FIG. 1, the display panel 120 may provide a mode for a luminance greater than or equal to a reference luminance to provide enhanced visibility when an illuminance around the electronic device 100 is higher than a reference illuminance. For example, the mode may be referred to as a high brightness mode (HBM). For example, the electronic device 100 may utilize LEDs in the display panel 120 for the mode. The mode may be provided through LEDs controlled by the display driver circuitry 110. A method of providing the mode may be exemplified in the description of FIG. 16.

FIG. 16 illustrates a method of providing a mode for a luminance greater than or equal to a reference luminance using a display panel according to an embodiment of the disclosure.

Referring to FIG. 16, the display panel 120 may include a plurality of LEDs. Each of the plurality of LEDs, which is a micro LED, may have a relatively small size, so the display driver circuitry 110 may emit a portion 1610 of the plurality of LEDs to while the illuminance around the electronic device 100 is lower than or equal to the reference illuminance, and not emit a remaining portion 1620 of the plurality of LEDs, as indicated by a state 1600. For example, the emission of the remaining portion 1620 of the plurality of LEDs may be limited by the display driver circuitry 110 while the illuminance is lower than or equal to the reference illuminance. For another example, the emission of the remaining portion 1620 of the plurality of LEDs may be limited by the display driver circuitry 110 while a remaining capacity of a rechargeable battery of the electronic device 100 is less than a reference capacity.

For example, the display driver circuitry 110 may change a state 1600 to a state 1650 based on information, a signal, or data obtained from a processor of the electronic device 100. For example, the state 1650 may indicate a state of providing the HBM. For example, the display driver circuitry 110 may provide the HBM by changing the state 1600 to the state 1650 based on the information, the signal, or the data obtained from the processor when data obtained through an illuminance sensor of the electronic device 100 indicates the illuminance higher than the reference illuminance. For example, for the HBM, the display driver circuitry 110 may emit not only the portion 1610 of the plurality of LEDs but also the remaining portion 1620 of the plurality of LEDs. For example, the electronic device 100 may provide enhanced visibility in an environment having an illuminance higher than the reference illuminance, by emitting the remaining portion 1620 of the plurality of LEDs, for the HBM, by using the display driver circuitry 110.

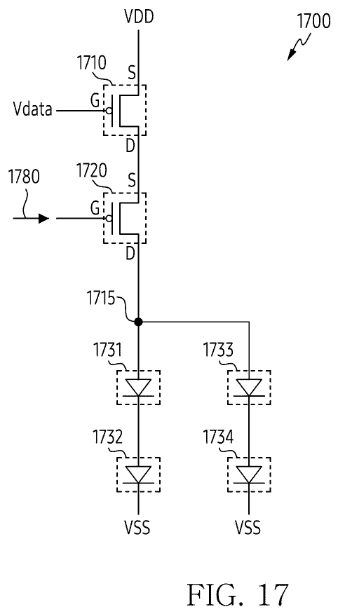

Referring back to FIG. 1, a portion of the plurality of LEDs in the display panel 120 may have a manufacturing fault as described above. For example, since each of the plurality of LEDs, which is a micro-LED, has a relatively small size, each of sub-pixels in the display panel 120 may have a structure for reducing occurrence of a dead partial region in the display panel 120 due to the portion of the plurality of LEDs having the manufacturing fault. For example, the manufacturing fault may include shorting of the portion of the plurality of LEDs. The structure may be exemplified in the description of FIGS. 17 to 20.

FIGS. 17 to 20 illustrate a sub-pixel in a display panel of an electronic device including three or more LEDs according to various embodiments of the disclosure.

Referring to FIG. 17, the display panel 120 may include sub-pixels 1700. For example, each of the sub-pixels 1700 may include a driving transistor 1710 including a gate electrode configured to obtain a data voltage (e.g., Vdata), a source electrode configured to obtain a driving voltage (e.g., VDD), and a drain electrode. For example, each of the sub-pixels 1700 may include a plurality of LEDs including a first LED 1731 including a first anode electrode connected to a node 1715 connectable to the drain electrode and a first cathode, a second LED 1732 including a second anode electrode connected to the first cathode and a second cathode, a third LED 1733 including a third anode electrode connected to the node 1715 and disconnected from the first cathode and a third cathode, and a fourth LED 1734 including a fourth anode electrode connected to the third cathode and disconnected from the first cathode and a fourth cathode.

For example, when the first LED 1731 among the plurality of LEDs is short-circuited, the display driver circuitry 110 may emit the second LED 1732, the third LED 1733, and the fourth LED 1734 according to the data voltage and the driving voltage by using the driving transistor 1710. For example, when the second LED 1732 among the plurality of LEDs is short-circuited, the display driver circuitry 110 may emit the first LED 1731, the third LED 1733, and the fourth LED 1734 according to the data voltage and the driving voltage by using the driving transistor 1710. For example, when the third LED 1733 among the plurality of LEDs is short-circuited, the display driver circuitry 110 may emit the first LED 1731, the second LED 1732, and the fourth LED 1734 according to the data voltage and the driving voltage by using the driving transistor 1710. For example, when the fourth LED 1734 among the plurality of LEDs is short-circuited, the display driver circuitry 110 may emit the first LED 1731, the second LED 1732, and the third LED 1733 according to the data voltage and the driving voltage by using the driving transistor 1710. For example, when the first LED 1731 and the third LED 1733 among the plurality of LEDs are short-circuited, the display driver circuitry 110 may emit the second LED 1732 and the fourth LED 1734 according to the data voltage and the driving voltage by using the driving transistor 1710. For example, when the first LED 1731 and the fourth LED 1734 among the plurality of LEDs are short-circuited, the display driver circuitry 110 may emit the second LED 1732 and the third LED 1733 according to the data voltage and the driving voltage by using the driving transistor 1710. For example, when the second LED 1732 and the third LED 1733 among the plurality of LEDs are short-circuited, the display driver circuitry 110 may emit the first LED 1731 and the fourth LED 1734 according to the data voltage and the driving voltage by using the driving transistor 1710. For example, when the second LED 1732 and the fourth LED 1734 among the plurality of LEDs are short-circuited, the display driver circuitry 110 may emit the first LED 1731 and the third LED 1733 according to the data voltage and the driving voltage by using the driving transistor 1710.

For example, each of the sub-pixels 1700 may further include an emission control transistor 1720 including another gate electrode configured to receive an emission signal 1780 from the display driver circuitry 110, another source electrode connected to the drain electrode, and another drain electrode connected to each of the first anode electrode and the third anode electrode via the node 1715.

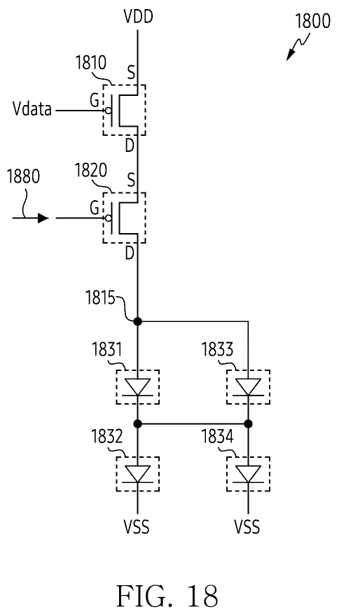

Referring to FIG. 18, the display panel 120 may include sub-pixels 1800. For example, each of the sub-pixel 1800 may include a driving transistor 1810 including a gate electrode configured to obtain a data voltage (e.g., Vdata), a source electrode configured to obtain a driving voltage (e.g., VDD), and a drain electrode. For example, each of the sub-pixels 1800 may include a plurality of LEDs including a first LED 1831 including a first anode electrode connected to a node 1815 connectable to the drain electrode and a first cathode, a second LED 1832 including a second anode electrode connected to the first cathode and a second cathode, a third LED 1833 including a third anode electrode connected to the node 1815 and disconnected from the first cathode and a third cathode connected to the first cathode and connected to the second anode electrode, and a fourth LED 1834 including a fourth anode electrode connected to the third cathode, connected to the first cathode, and connected to the second anode electrode and a fourth cathode.

For example, when the first LED 1831 among the plurality of LEDs is short-circuited, the display driver circuitry 110 may emit the second LED 1832 and the fourth LED 1834 according to the data voltage and the driving voltage by using the driving transistor 1810. For example, when the second LED 1832 among the plurality of LEDs is short-circuited, the display driver circuitry 110 may emit the first LED 1831 and the third LED 1833 according to the data voltage and the driving voltage by using the driving transistor 1810. For example, when the third LED 1833 among the plurality of LEDs is short-circuited, the display driver circuitry 110 may emit the second LED 1832 and the fourth LED 1834 according to the data voltage and the driving voltage by using the driving transistor 1810. For example, when the fourth LED 1834 among the plurality of LEDs is short-circuited, the display driver circuitry 110 may emit the first LED 1831 and the third LED 1833 according to the data voltage and the driving voltage by using the driving transistor 1810. For example, when the first LED 1831 and the third LED 1833 among the plurality of LEDs are short-circuited, the display driver circuitry 110 may emit the second LED 1832 and the fourth LED 1834 according to the data voltage and the driving voltage by using the driving transistor 1810. For example, when the second LED 1832 and the fourth LED 1834 among the plurality of LEDs are short-circuited, the display driver circuitry 110 may emit the first LED 1831 and the third LED 1833 according to the data voltage and the driving voltage by using the driving transistor 1810.

For example, each of the sub-pixels 1800 may further include an emission control transistor 1820 including another gate electrode configured to receive an emission signal 1880 from the display driver circuitry 110, another source electrode connected to the drain electrode, and another drain electrode connected to each of the first anode electrode and the third anode electrode via the node 1815.

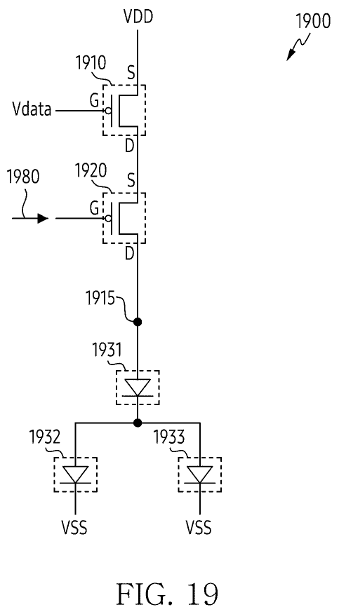

Referring to FIG. 19, the display panel 120 may include sub-pixels 1900. For example, each of the sub-pixels 1900 may include a driving transistor 1910 including a gate electrode configured to obtain a data voltage (e.g., Vdata), a source electrode configured to obtain a driving voltage (e.g., VDD), and a drain electrode. For example, each of the sub-pixels 1900 may include a plurality of LEDs including a first LED 1931 including a first anode electrode connected to a node 1915 connectable to the drain electrode and a first cathode, a second LED 1932 including a second anode electrode connected to the first cathode and a second cathode, and a third LED 1933 including a third anode electrode connected to the first cathode and disconnected from the second cathode and a third cathode.

For example, when the first LED 1931 among the plurality of LEDs is short-circuited, the display driver circuitry 110 may emit the second LED 1932 and the third LED 1933 according to the data voltage and the driving voltage by using the driving transistor 1910. For example, when the second LED 1932 among the plurality of LEDs is short-circuited, the display driver circuitry 110 may emit the first LED 1931 according to the data voltage and the driving voltage by using the driving transistor 1910. For example, when the third LED 1933 among the plurality of LEDs is short-circuited, the display driver circuitry 110 may emit the first LED 1931 according to the data voltage and the driving voltage by using the driving transistor 1910. For example, when the second LED 1932 and the third LED 1933 among the plurality of LEDs are short-circuited, the display driver circuitry 110 may emit the first LED 1931 according to the data voltage and the driving voltage by using the driving transistor 1910.

For example, each of the sub-pixels 1900 may further include an emission control transistor 1920 including another gate electrode configured to receive an emission signal 1980 from the display driver circuitry 110, another source electrode connected to the drain electrode, and another drain electrode connected to each of the first anode electrode and the third anode electrode via the node 1915.

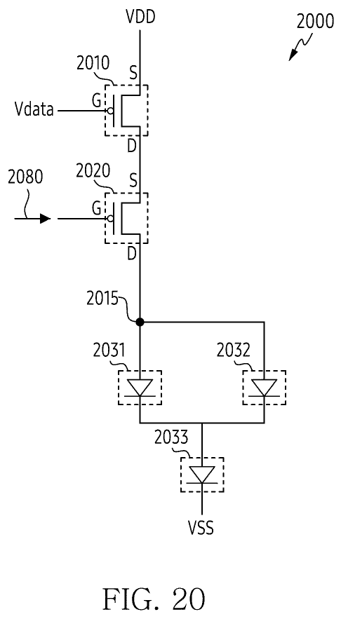

Referring to FIG. 20, the display panel 120 may include sub-pixels 2000. For example, each of the sub-pixels 2000 may include a driving transistor 2010 including a gate electrode configured to obtain a data voltage (e.g., Vdata), a source electrode configured to obtain a driving voltage (e.g., VDD), and a drain electrode. For example, each of the sub-pixels 2000 may include a plurality of LEDs including a first LED 2031 including a first anode electrode connected to a node 2015 connectable to the drain electrode and a first cathode, a second LED 2032 including a second anode electrode connected to the node 2015 and disconnected from the first cathode and a second cathode, and a third LED 2033 including a third anode electrode connected to each of the first cathode and the second cathode and a third cathode.

For example, when the first LED 2031 among the plurality of LEDs is short-circuited, the display driver circuitry 110 may emit the third LED 2033 according to the data voltage and the driving voltage by using the driving transistor 2010. For example, when the second LED 2032 among the plurality of LEDs is short-circuited, the display driver circuitry 110 may emit the third LED 2033 according to the data voltage and the driving voltage by using the driving transistor 2010. For example, when the third LED 2033 among the plurality of LEDs is short-circuited, the display driver circuitry 110 may emit the first LED 2031 and the second LED 2032 according to the data voltage and the driving voltage by using the driving transistor 2010. For example, when the first LED 2031 and the second LED 2032 among the plurality of LEDs are short-circuited, the display driver circuitry 110 may emit the third LED 2033 according to the data voltage and the driving voltage by using the driving transistor 2010.

For example, each of the sub-pixels 2000 may further include an emission control transistor 2020 including another gate electrode configured to receive an emission signal 2080 from the display driver circuitry 110, another source electrode connected to the drain electrode, and another drain electrode connected to each of the first anode electrode and the third anode electrode via the node 2015.

The above-described operations may be implemented in the electronic device 2101 exemplified below. For example, the electronic device 2101 may include a display module 2160 exemplified in the description of FIG. 22.

FIG. 21 is a block diagram illustrating an electronic device 2101 in a network environment 2100 according to an embodiment of the disclosure.

Referring to FIG. 21, the electronic device 2101 in the network environment 2100 may communicate with an electronic device 2102 via a first network 2198 (e.g., a short-range wireless communication network), or at least one of an electronic device 2104 or a server 2108 via a second network 2199 (e.g., a long-range wireless communication network). According to an embodiment, the electronic device 2101 may communicate with the electronic device 2104 via the server 2108. According to an embodiment, the electronic device 2101 may include a processor 2120, memory 2130, an input module 2150, a sound output module 2155, a display module 2160, an audio module 2170, a sensor module 2176, an interface 2177, a connecting terminal 2178, a haptic module 2179, a camera module 2180, a power management module 2188, a battery 2189, a communication module 2190, a subscriber identification module (SIM) 2196, or an antenna module 2197. In some embodiments, at least one of the components (e.g., the connecting terminal 2178) may be omitted from the electronic device 2101, or one or more other components may be added in the electronic device 2101. In some embodiments, some of the components (e.g., the sensor module 2176, the camera module 2180, or the antenna module 2197) may be implemented as a single component (e.g., the display module 2160).

The processor 2120 may execute, for example, software (e.g., a program 2140) to control at least one other component (e.g., a hardware or software component) of the electronic device 2101 coupled with the processor 2120, and may perform various data processing or computation. According to an embodiment, as at least part of the data processing or computation, the processor 2120 may store a command or data received from another component (e.g., the sensor module 2176 or the communication module 2190) in volatile memory 2132, process the command or the data stored in the volatile memory 2132, and store resulting data in non-volatile memory 2134. According to an embodiment, the processor 2120 may include a main processor 2121 (e.g., a central processing unit (CPU) or an application processor (AP)), or an auxiliary processor 2123 (e.g., a graphics processing unit (GPU), a neural processing unit (NPU), an image signal processor (ISP), a sensor hub processor, or a communication processor (CP)) that is operable independently from, or in conjunction with, the main processor 2121. For example, when the electronic device 2101 includes the main processor 2121 and the auxiliary processor 2123, the auxiliary processor 2123 may be adapted to consume less power than the main processor 2121, or to be specific to a specified function. The auxiliary processor 2123 may be implemented as separate from, or as part of the main processor 2121.

The auxiliary processor 2123 may control at least some of functions or states related to at least one component (e.g., the display module 2160, the sensor module 2176, or the communication module 2190) among the components of the electronic device 2101, instead of the main processor 2121 while the main processor 2121 is in an inactive (e.g., sleep) state, or together with the main processor 2121 while the main processor 2121 is in an active state (e.g., executing an application). According to an embodiment, the auxiliary processor 2123 (e.g., an image signal processor or a communication processor) may be implemented as part of another component (e.g., the camera module 2180 or the communication module 2190) functionally related to the auxiliary processor 2123. According to an embodiment, the auxiliary processor 2123 (e.g., the neural processing unit) may include a hardware structure specified for artificial intelligence model processing. An artificial intelligence model may be generated by machine learning. Such learning may be performed, e.g., by the electronic device 2101 where the artificial intelligence is performed or via a separate server (e.g., the server 2108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 2130 may store various data used by at least one component (e.g., the processor 2120 or the sensor module 2176) of the electronic device 2101. The various data may include, for example, software (e.g., the program 2140) and input data or output data for a command related thereto. The memory 2130 may include the volatile memory 2132 or the non-volatile memory 2134.

The program 2140 may be stored in the memory 2130 as software, and may include, for example, an operating system (OS) 2142, middleware 2144, or an application 2146.

The input module 2150 may receive a command or data to be used by another component (e.g., the processor 2120) of the electronic device 2101, from the outside (e.g., a user) of the electronic device 2101. The input module 2150 may include, for example, a microphone, a mouse, a keyboard, a key (e.g., a button), or a digital pen (e.g., a stylus pen).

The sound output module 2155 may output sound signals to the outside of the electronic device 2101. The sound output module 2155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 2160 may visually provide information to the outside (e.g., a user) of the electronic device 2101. The display module 2160 may include, for example, a display, a hologram device, or a projector and control circuitry to control a corresponding one of the display, hologram device, and projector. According to an embodiment, the display module 2160 may include a touch sensor adapted to detect a touch, or a pressure sensor adapted to measure the intensity of force incurred by the touch.

The audio module 2170 may convert a sound into an electrical signal and vice versa. According to an embodiment, the audio module 2170 may obtain the sound via the input module 2150, or output the sound via the sound output module 2155 or a headphone of an external electronic device (e.g., an electronic device 2102) directly (e.g., wiredly) or wirelessly coupled with the electronic device 2101.

The sensor module 2176 may detect an operational state (e.g., power or temperature) of the electronic device 2101 or an environmental state (e.g., a state of a user) external to the electronic device 2101, and then generate an electrical signal or data value corresponding to the detected state. According to an embodiment, the sensor module 2176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2177 may support one or more specified protocols to be used for the electronic device 2101 to be coupled with the external electronic device (e.g., the electronic device 2102) directly (e.g., wiredly) or wirelessly. According to an embodiment, the interface 2177 may include, for example, a high definition multimedia interface (HDMI), a universal serial bus (USB) interface, a secure digital (SD) card interface, or an audio interface.

A connecting terminal 2178 may include a connector via which the electronic device 2101 may be physically connected with the external electronic device (e.g., the electronic device 2102). According to an embodiment, the connecting terminal 2178 may include, for example, an HDMI connector, a USB connector, an SD card connector, or an audio connector (e.g., a headphone connector).

The haptic module 2179 may convert an electrical signal into a mechanical stimulus (e.g., a vibration or a movement) or electrical stimulus which may be recognized by a user via his tactile sensation or kinesthetic sensation. According to an embodiment, the haptic module 2179 may include, for example, a motor, a piezoelectric element, or an electric stimulator.

The camera module 2180 may capture a still image or moving images. According to an embodiment, the camera module 2180 may include one or more lenses, image sensors, image signal processors, or flashes.

The power management module 2188 may manage power supplied to the electronic device 2101. According to an embodiment, the power management module 2188 may be implemented as at least part of, for example, a power management integrated circuit (PMIC).

The battery 2189 may supply power to at least one component of the electronic device 2101. According to an embodiment, the battery 2189 may include, for example, a primary cell which is not rechargeable, a secondary cell which is rechargeable, or a fuel cell.

The communication module 2190 may support establishing a direct (e.g., wired) communication channel or a wireless communication channel between the electronic device 2101 and the external electronic device (e.g., the electronic device 2102, the electronic device 2104, or the server 2108) and performing communication via the established communication channel. The communication module 2190 may include one or more communication processors that are operable independently from the processor 2120 (e.g., the application processor (AP)) and supports a direct (e.g., wired) communication or a wireless communication. According to an embodiment, the communication module 2190 may include a wireless communication module 2192 (e.g., a cellular communication module, a short-range wireless communication module, or a global navigation satellite system (GNSS) communication module) or a wired communication module 2194 (e.g., a local area network (LAN) communication module or a power line communication (PLC) module). A corresponding one of these communication modules may communicate with the external electronic device via the first network 2198 (e.g., a short-range communication network, such as Bluetooth™, wireless-fidelity (Wi-Fi) direct, or infrared data association (IrDA)) or the second network 2199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 2192 may identify and authenticate the electronic device 2101 in a communication network, such as the first network 2198 or the second network 2199, using subscriber information (e.g., international mobile subscriber identity (IMSI)) stored in the subscriber identification module 2196.

The wireless communication module 2192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 2192 may support a high-frequency band (e.g., the millimeter wave (mmWave) band) to achieve, e.g., a high data transmission rate. The wireless communication module 2192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 2192 may support various requirements specified in the electronic device 2101, an external electronic device (e.g., the electronic device 2104), or a network system (e.g., the second network 2199). According to an embodiment, the wireless communication module 2192 may support a peak data rate (e.g., 20 gigabits per second (Gbps) or more) for implementing eMBB, loss coverage (e.g., 2164 dB or less) for implementing mMTC, or U-plane latency (e.g., 0.5 ms or less for each of downlink (DL) and uplink (UL), or a round trip of 21 ms or less) for implementing URLLC.

The antenna module 2197 may transmit or receive a signal or power to or from the outside (e.g., the external electronic device) of the electronic device 2101. According to an embodiment, the antenna module 2197 may include an antenna including a radiating element composed of a conductive material or a conductive pattern formed in or on a substrate (e.g., a printed circuit board (PCB)). According to an embodiment, the antenna module 2197 may include a plurality of antennas (e.g., array antennas). In such a case, at least one antenna appropriate for a communication scheme used in the communication network, such as the first network 2198 or the second network 2199, may be selected, for example, by the communication module 2190 (e.g., the wireless communication module 2192) from the plurality of antennas. The signal or the power may then be transmitted or received between the communication module 2190 and the external electronic device via the selected at least one antenna. According to an embodiment, another component (e.g., a radio frequency integrated circuit (RFIC)) other than the radiating element may be additionally formed as part of the antenna module 2197.

According to various embodiments, the antenna module 2197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 2101 and the external electronic device 2104 via the server 2108 coupled with the second network 2199. Each of the electronic devices 2102 or 2104 may be a device of a same type as, or a different type, from the electronic device 2101. According to an embodiment, all or some of operations to be executed at the electronic device 2101 may be executed at one or more of the external electronic devices 2102, 2104, or 2108. For example, if the electronic device 2101 should perform a function or a service automatically, or in response to a request from a user or another device, the electronic device 2101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 2101. The electronic device 2101 may provide the outcome, with or without further processing of the outcome, as at least part of a reply to the request. To that end, a cloud computing, distributed computing, mobile edge computing (MEC), or client-server computing technology may be used, for example. The electronic device 2101 may provide ultra low-latency services using, e.g., distributed computing or mobile edge computing. In another embodiment, the external electronic device 2104 may include an internet-of-things (IoT) device. The server 2108 may be an intelligent server using machine learning and/or a neural network. According to an embodiment, the external electronic device 2104 or the server 2108 may be included in the second network 2199. The electronic device 2101 may be applied to intelligent services (e.g., smart home, smart city, smart car, or healthcare) based on 5G communication technology or IoT-related technology.

FIG. 22 is a block diagram 2200 illustrating the display module 2160 according to an embodiment of the disclosure.

Referring to FIG. 22, the display module 2160 may include a display 2210 and a display driver integrated circuit (DDI) 2230 to control the display 2210. The DDI 2230 may include an interface module 2231, memory 2233 (e.g., buffer memory), an image processing module 2235, or a mapping module 2237. The DDI 2230 may receive image information that contains image data or an image control signal corresponding to a command to control the image data from another component of the electronic device 2101 via the interface module 2231. For example, according to an embodiment, the image information may be received from the processor 2120 (e.g., the main processor 2121 (e.g., an application processor)) or the auxiliary processor 2123 (e.g., a graphics processing unit) operated independently from the function of the main processor 2121. The DDI 2230 may communicate, for example, with touch circuitry 2250 or the sensor module 2176 via the interface module 2231. The DDI 2230 may also store at least part of the received image information in the memory 2233, for example, on a frame by frame basis. The image processing module 2235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 2210. The mapping module 2237 may generate a voltage value or a current value corresponding to the image data pre-processed or post-processed by the image processing module 2235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 2210 may be driven, for example, based at least in part on the voltage value or the current value such that visual information (e.g., a text, an image, or an icon) corresponding to the image data may be displayed via the display 2210.

According to an embodiment, the display module 2160 may further include the touch circuitry 2250. The touch circuitry 2250 may include a touch sensor 2251 and a touch sensor IC 2253 to control the touch sensor 2251. The touch sensor IC 2253 may control the touch sensor 2251 to sense a touch input or a hovering input with respect to a certain position on the display 2210. To achieve this, for example, the touch sensor 2251 may detect (e.g., measure) a change in a signal (e.g., a voltage, a quantity of light, a resistance, or a quantity of one or more electric charges) corresponding to the certain position on the display 2210. The touch circuitry 2250 may provide input information (e.g., a position, an area, a pressure, or a time) indicative of the touch input or the hovering input detected via the touch sensor 2251 to the processor 2120. According to an embodiment, at least part (e.g., the touch sensor IC 2253) of the touch circuitry 2250 may be formed as part of the display 2210 or the DDI 2230, or as part of another component (e.g., the auxiliary processor 2123) disposed outside the display module 2160.

According to an embodiment, the display module 2160 may further include at least one sensor (e.g., a fingerprint sensor, an iris sensor, a pressure sensor, or an illuminance sensor) of the sensor module 2176 or a control circuit for the at least one sensor. In such a case, the at least one sensor or the control circuit for the at least one sensor may be embedded in one portion of a component (e.g., the display 2210, the DDI 2230, or the touch circuitry 2250)) of the display module 2160. For example, when the sensor module 2176 embedded in the display module 2160 includes a biometric sensor (e.g., a fingerprint sensor), the biometric sensor may obtain biometric information (e.g., a fingerprint image) corresponding to a touch input received via a portion of the display 2210. As another example, when the sensor module 2176 embedded in the display module 2160 includes a pressure sensor, the pressure sensor may obtain pressure information corresponding to a touch input received via a partial or whole area of the display 2210. According to an embodiment, the touch sensor 2251 or the sensor module 2176 may be disposed between pixels in a pixel layer of the display 2210, or over or under the pixel layer.

As described above, an electronic device 100 may comprise display driver circuitry 110 and a display panel 120. According to an embodiment, a sub-pixel 300 in the display panel may include a plurality of light emitting diodes (LEDs) including a first LED 321 and a second LED 322, a driving transistor 310 including a first gate electrode configured to obtain a data voltage, a drain electrode, and a source electrode, a first emission control transistor 311 including a second gate electrode, a second source electrode connected to the first drain electrode, and a second drain electrode connected to an anode electrode of the first LED 321 from among the LEDs, and a second emission control transistor 312 including a third gate electrode, a third source electrode connected to the first drain electrode, and a third drain electrode connected to an anode electrode of the second LED 322 from among the LEDs. According to an embodiment, the display driver circuitry 110 may be configured to, in a first emission interval in a time interval corresponding to a refresh rate, provide a first emission signal to the second gate electrode to provide, using the driving transistor 310, a current according to the data voltage to the first LED 321 from among the LEDs. According to an embodiment, the display driver circuitry 110 may be configured to, in a second emission interval in the time interval subsequent to the first emission interval, provide a second emission signal to the third gate electrode to provide, using the driving transistor 310, the current to the second LED 322 from among the LEDs.

According to an embodiment, the LEDs may include a third LED in the sub-pixel 300. The sub-pixel 300 may include a third emission control transistor including a fourth gate electrode, a fourth source electrode connected to the first drain electrode, and a fourth drain electrode connected to an anode electrode of the third LED from among the LEDs. According to an embodiment, the display driver circuitry 110 may be configured to, when the third LED does not have a manufacturing fault, in a third emission interval in the time interval subsequent to the second emission interval, provide a third emission signal to the fourth gate electrode to provide, using the driving transistor 310, the current to the third LED from among the LEDs. According to an embodiment, the display driver circuitry 110 may be configured to, when the third LED has a manufacturing fault, in the third emission interval, forgo providing the third emission signal to the fourth gate electrode.

According to an embodiment, the display driver circuitry 110 may be configured to, when the third LED has a manufacturing fault, in the third emission interval, provide the first emission signal or the second emission signal to the second gate electrode or the third gate electrode to provide, using the driving transistor 310, the current to the first LED 321 or the second LED 322 from among the LEDs.

According to an embodiment, the display panel may include another sub-pixel in another pixel different from a pixel including the sub-pixel 300. According to an embodiment, the other sub-pixel may include a plurality of LEDs including a third LED and a fourth LED. According to an embodiment, the other sub-pixel may include another driving transistor including a fourth gate electrode configured to obtain another data voltage, a fourth drain electrode, and a fourth source electrode. According to an embodiment, the other sub-pixel may include a third emission control transistor including a fifth gate electrode, a fifth source electrode connected to the fourth drain electrode, and a fifth drain electrode connected to the third LED from among the LEDs in the other sub-pixel. According to an embodiment, the other sub-pixel may include a fourth emission control transistor including a sixth gate electrode, a sixth source electrode connected to the fourth drain electrode, and a sixth drain electrode connected to the fourth LED from among the LEDS in the other sub-pixel. According to an embodiment, the display driver circuitry may be configured to, when the third LED from among the third and fourth LEDs has a manufacturing fault, in the first emission interval, forgo providing a third emission signal to the fifth gate electrode, and in the second emission interval, provide a fourth emission signal to the sixth gate electrode to provide, using the other driving transistor, another current according to the other data voltage to the fourth LED from among the LEDS in the other sub-pixel. According to an embodiment, the display driver circuitry may be configured to, when the fourth LED from among the third and fourth LEDs has a manufacturing fault, in the first emission interval, provide the third emission signal to the fifth gate electrode to provide, using the other driving transistor, the other current to the third LED from among the LEDS in the other sub-pixel, and in the second emission interval, forgo providing the fourth emission signal to the sixth gate electrode.

According to an embodiment, the display driver circuitry 110 may be configured to, when the third LED from among the third and fourth LEDs has a manufacturing fault, in the first emission interval, provide the fourth emission signal to the sixth gate electrode to provide, using the other driving transistor, the other current to the fourth LED from among the LEDs in the other sub-pixel. According to an embodiment, the display driver circuitry 110 may be configured to, when the fourth LED from among the third and fourth LEDs has a manufacturing fault, in the second emission interval, provide the third emission signal to the fifth gate electrode to provide, using the other driving transistor, the other current to the third LED from among the LEDs in the other sub-pixel.

According to an embodiment, the other current may be a first current. According to an embodiment, the display driver circuitry 110 may be configured to, when both the third and fourth LEDs do not have a manufacturing fault, in the first emission interval, provide the third emission signal to the fifth gate electrode to provide a second current to the third LED from among the LEDs in the other sub-pixel, and in the second emission interval, provide the fourth emission signal to the sixth gate electrode to provide the second current to the fourth LED from among the LEDs in the other sub-pixel. According to an embodiment, the first current provided when the third LED from among the third and fourth LEDs has a manufacturing fault or the fourth LED from among the third and fourth LEDs has a manufacturing fault may be higher than the second current provided when both the third and fourth LEDs do not have a manufacturing fault.

According to an embodiment, the sub-pixel 300 may include a capacitor connected to the first gate electrode. According to an embodiment, the sub-pixel 300 may include a first operation control transistor including a fourth source electrode configured to obtain a driving voltage, a fourth gate electrode, and a fourth drain electrode connected to the first source electrode. According to an embodiment, the sub-pixel 300 may include a second operation control transistor including a fifth source electrode configured to obtain the driving voltage, a fifth gate electrode, and a fifth drain electrode connected to the first source electrode. According to an embodiment, the display driver circuitry 110 may be configured to, in the first emission interval, provide the first emission signal to the fourth gate electrode. According to an embodiment, the display driver circuitry 110 may be configured to, in the second emission interval, provide the second emission signal to the fifth gate electrode.

According to an embodiment, the display driver circuitry 110 may be configured to, for a first mode, in the first emission interval, provide the first emission signal, and in the second emission interval, provide the second emission signal. According to an embodiment, the display driver circuitry 110 may be configured to, for a second mode displaying via the display panel 120 an image with a power lower than a power consumed in accordance with displaying via the display panel 120 an image based on the first mode, in the first emission interval, provide the first emission signal, and in the second emission interval, provide the first emission signal to the second gate electrode to provide the current to the first LED 321 from among the LEDs using the driving transistor 310.

According to an embodiment, the display driver circuitry 110 may be configured to, for a first mode, in the first emission interval, provide the first emission signal, and in the second emission interval, provide the second emission signal. According to an embodiment, the display driver circuitry 110 may be configured to, for a second mode displaying via the display panel 120 an image with a power lower than a power consumed in accordance with displaying via the display panel 120 an image based on the first mode, in the first emission interval, provide the first emission signal, and in the second emission interval, forgo respectively providing each of the first emission signal and the second emission signal to each of the second gate electrode and the third gate electrode.

According to an embodiment, the display panel 120 may include another sub-pixel in another pixel immediately below a pixel including the sub-pixel. According to an embodiment, the other sub-pixel may include a plurality of LEDs including the second LED 322 or 1121 shared with the sub-pixel, and a third LED 1131. According to an embodiment, the other sub-pixel may include another driving transistor 1220 including a fourth gate electrode configured to obtain another data voltage, a fourth drain electrode, and a fourth source electrode. According to an embodiment, the other sub-pixel may include the second emission control transistor 312 or 1212 shared with the sub-pixel. According to an embodiment, the other sub-pixel may include a third emission control transistor 1213 including a fifth gate electrode, a fifth source electrode connected to the fourth drain electrode, and a fifth drain electrode connected to an anode electrode of the third LED 1131. According to an embodiment, the third source electrode of the second emission control transistor 312 or 1212 may be connectable to the first drain electrode or the fourth drain electrode. According to an embodiment, the display driver circuitry 110 may be configured to, in the first emission interval, provide the first emission signal to the second gate electrode based on a timing according to a position of the sub-pixel, for providing the current, using the driving transistor 310 or 1210, to the first LED 321 or 1111 from among the LEDs in the sub-pixel. According to an embodiment, the display driver circuitry 110 may be configured to, in the first emission interval, while the third source electrode is connected to the fourth drain electrode from among the first and fourth drain electrodes, provide the second emission signal to the third gate electrode based on a timing according to a position of the other sub-pixel immediately positioned below the sub-pixel, for providing another current according to the other data voltage to the second LED 322 or 1121 from among the LEDs in the other sub-pixel using the other driving transistor 1220. According to an embodiment, the display driver circuitry 110 may be configured to, in the second emission interval, while the third source electrode is connected to the first drain electrode from among the first and fourth drain electrodes, provide the second emission signal to the third gate electrode based on a timing according to the position of the sub-pixel, for providing the current, using the driving transistor 310 or 1210, to the second LED 322 or 1121 from among the LEDs in the sub-pixel. According to an embodiment, the display driver circuitry 110 may be configured to, in the second emission interval, provide a third emission signal to the fifth gate electrode based on a timing according to the position of the other sub-pixel, for providing the other current, using the other driving transistor 1220, to the third LED 1131 from among the LEDs in the other sub-pixel.

According to an embodiment, the sub-pixel may include a switch for connecting the third source electrode to the first drain electrode or the fourth drain electrode. According to an embodiment, the other sub-pixel may include the switch shared with the sub-pixel. According to an embodiment, the display driver circuitry 110 may be configured to provide a second control signal to the switch to connect the third source electrode to the fourth drain electrode from among the first and fourth drain electrodes through the switch in the first emission interval. According to an embodiment, the display driver circuitry 110 may be configured to provide a first control signal to the switch to connect the third source electrode to the first drain electrode from among the first and fourth drain electrodes through the switch in the second emission interval.

According to an embodiment, the first control signal may be provided to the switch to connect the third source electrode to the first drain electrode and disconnect the third source electrode from the fourth drain electrode. According to an embodiment, the second control signal may be provided to the switch to connect the third source electrode to the fourth drain electrode and disconnect the third source electrode from the first drain electrode.

According to an embodiment, the display driver circuitry 110 may be configured to, when the third LED 1131 does not have a manufacturing fault, in the second emission interval, provide the third emission signal to the fifth gate electrode, for providing the other current to the third LED 1131. According to an embodiment, the display driver circuitry 110 may be configured to, when the third LED 1131 has a manufacturing fault, in the second emission interval, forgo providing the third emission signal to the fifth gate electrode.

According to an embodiment, each of the LEDs may have a size between about 10 micrometers and about 30 micrometers.

As described above, an electronic device 100 may include a display panel 120 including sub-pixels. According to an embodiment, each of the sub-pixels may include a driving transistor 1710 including a gate electrode configured to obtain a data voltage, a source electrode configured to obtain a driving voltage, and a drain electrode. According to an embodiment, each of the sub-pixels may include a plurality of light emitting diodes (LEDs) including a first LED 1731 including a first anode electrode connected to a node connectable to the drain electrode and a first cathode, a second LED 1732 including a second anode electrode connected to the first cathode and a second cathode, a third LED 1733 including a third anode electrode connected to the node and disconnected from the first cathode and a third cathode, and a fourth LED 1734 including a fourth anode electrode connected to the third cathode and disconnected from the first cathode and a fourth cathode.

According to an embodiment, the electronic device 100 may include display driver circuitry 110. According to an embodiment, the display driver circuitry 110 may be configured to, when the first LED 1731 from among the plurality of LEDs is short-circuited, control the second LED 1732, the third LED 1733, and the fourth LED 1734 to emit light according to the data voltage and the driving voltage by using the driving transistor 1710. According to an embodiment, the display driver circuitry 110 may be configured to, when the second LED 1732 from among the plurality of LEDs is short-circuited, control the first LED 1731, the third LED 1733, and the fourth LED 1734 to emit light according to the data voltage and the driving voltage by using the driving transistor 1710. According to an embodiment, the display driver circuitry 110 may be configured to, when the third LED 1733 from among the plurality of LEDs is short-circuited, control the first LED 1731, the second LED 1732, and the fourth LED 1734 to emit light according to the data voltage and the driving voltage by using the driving transistor 1710. According to an embodiment, the display driver circuitry 110 may be configured to, when the fourth LED 1734 from among the plurality of LEDs is short-circuited, control the first LED 1731, the second LED 1732, and the third LED 1733 to emit light according to the data voltage and the driving voltage by using the driving transistor 1710. According to an embodiment, the display driver circuitry 110 may be configured to, when the first LED 1731 and the third LED 1733 among the plurality of LEDs are short-circuited, control the second LED 1732 and the fourth LED 1734 to emit light according to the data voltage and the driving voltage by using the driving transistor 1710. According to an embodiment, the display driver circuitry 110 may be configured to, when the first LED 1731 and the fourth LED 1734 from among the plurality of LEDs are short-circuited, control the second LED 1732 and the third LED 1733 to emit light according to the data voltage and the driving voltage by using the driving transistor 1710. According to an embodiment, the display driver circuitry 110 may be configured to, when the second LED 1732 and the third LED 1733 from among the plurality of LEDs are short-circuited, control the first LED 1731 and the fourth LED 1734 to emit light according to the data voltage and the driving voltage by using the driving transistor 1710. According to an embodiment, the display driver circuitry 110 may be configured to, when the second LED 1732 and the fourth LED 1734 from among the plurality of LEDs are short-circuited, control the first LED 1731 and the third LED 1733 to emit light according to the data voltage and the driving voltage by using the driving transistor 1710.

According to an embodiment, each of the sub-pixels may include an emission control transistor including another gate electrode configured to receive an emission signal from the display driver circuitry 110, another source electrode connected to the drain electrode, and another drain electrode connected to each of the first anode electrode and the third anode electrode through the node.

As described above, an electronic device 100 may include a display panel 120 including sub-pixels. According to an embodiment, each of the sub-pixels may include a driving transistor 1810 including a gate electrode configured to obtain a data voltage, a source electrode configured to obtain a driving voltage, and a drain electrode. According to an embodiment, each of the sub-pixels may include a plurality of light emitting diodes (LEDs) including a first LED 1831 including a first anode electrode connected to a node connectable to the drain electrode and a first cathode, a second LED 1832 including a second anode electrode connected to the first cathode and a second cathode, a third LED 1833 including a third anode electrode connected to the node and disconnected from the first cathode and a third cathode connected to the first cathode and connected to the second anode electrode, and a fourth LED 1834 including a fourth anode electrode connected to the third cathode, connected to the first cathode, and connected to the second anode electrode and a fourth cathode.

According to an embodiment, the electronic device 100 may include display driver circuitry 110. According to an embodiment, the display driver circuitry 110 may be configured to, when the first LED 1831 from among the plurality of LEDs is short-circuited, control the second LED 1832 and the fourth LED 1834 to emit light according to the data voltage and the driving voltage by using the driving transistor 1810. According to an embodiment, the display driver circuitry 110 may be configured to, when the second LED 1832 from among the plurality of LEDs is short-circuited, control the first LED 1831 and the third LED 1833 to emit light according to the data voltage and the driving voltage by using the driving transistor 1810. According to an embodiment, the display driver circuitry 110 may be configured to, when the third LED 1833 from among the plurality of LEDs is short-circuited, control the second LED 1832 and the fourth LED 1834 to emit light according to the data voltage and the driving voltage by using the driving transistor 1810. According to an embodiment, the display driver circuitry 110 may be configured to, when the fourth LED 1834 from among the plurality of LEDs is short-circuited, control the first LED 1831 and the third LED 1833 to emit light according to the data voltage and the driving voltage by using the driving transistor 1810. According to an embodiment, the display driver circuitry 110 may be configured to, when the first LED 1831 and the third LED 1833 from among the plurality of LEDs are short-circuited, control the second LED 1832 and the fourth LED 1834 to emit light according to the data voltage and the driving voltage by using the driving transistor 1810. According to an embodiment, the display driver circuitry 110 may be configured to, when the second LED 1832 and the fourth LED 1834 from among the plurality of LEDs are short-circuited, control the first LED 1831 and the third LED 1833 to emit light according to the data voltage and the driving voltage by using the driving transistor 1810.

According to an embodiment, each of the sub-pixels may include an emission control transistor including another gate electrode configured to receive an emission signal from the display driver circuitry 110, another source electrode connected to the drain electrode, and another drain electrode connected to each of the first anode electrode and the third anode electrode through the node.

As described above, the electronic device 100 may include a display panel 120 including sub-pixels. According to an embodiment, each of the sub-pixels may include a gate electrode configured to obtain a data voltage, a source electrode configured to obtain a driving voltage, and a driving transistor 1910 including a drain electrode. According to an embodiment, each of the sub-pixels may include a plurality of LEDs including a first LED light emitting diode 1931 including a first anode electrode connected to a node connectable to the drain electrode and a first cathode, a second LED 1932 including a second anode electrode connected to the first cathode and a second cathode, and a third LED 1933 including a third anode electrode connected to the first cathode and disconnected from the second cathode and a third cathode.

As described above, an electronic device 100 may include a display panel 120 including sub-pixels. According to an embodiment, each of the sub-pixels may include a gate electrode configured to obtain a data voltage, a source electrode configured to obtain a driving voltage, and a driving transistor 2010 including a drain electrode. According to an embodiment, each of the sub-pixels may include a plurality of LEDs including a first LED light emitting diode 2031 including a first anode electrode connected to a node connectable to the drain electrode and a first cathode, a second LED 2032 including a second anode electrode connected to the first cathode and a second cathode, and a third LED 2033 including a third anode electrode connected to the node and disconnected from the first cathode and a third cathode connected to the first cathode and connected to the second anode electrode.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 2140) including one or more instructions that are stored in a storage medium (e.g., internal memory 2136 or external memory 2138) that is readable by a machine (e.g., the electronic device 2101). For example, a processor (e.g., the processor 2120) of the machine (e.g., the electronic device 2101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
display driver circuitry; and
a display panel,
wherein a sub-pixel in the display panel includes:
a plurality of light emitting diodes (LEDs) including a first LED and a second LED,
a driving transistor including a first gate electrode configured to obtain a data voltage, a drain electrode, and a first source electrode,
a first emission control transistor including a second gate electrode, a second source electrode connected to the first drain electrode, and a second drain electrode connected to an anode electrode of the first LED from among the LEDs, and
a second emission control transistor including a third gate electrode, a third source electrode connected to the first drain electrode, and a third drain electrode connected to an anode electrode of the second LED from among the LEDs, and
wherein the display driver circuitry is configured to:
in a first emission interval in a time interval corresponding to a refresh rate, provide a first emission signal to the second gate electrode to provide, using the driving transistor, a current according to the data voltage to the first LED from among the LEDs, and
in a second emission interval in the time interval subsequent to the first emission interval, provide a second emission signal to the third gate electrode to provide, using the driving transistor, the current to the second LED from among the LEDs.

2. The electronic device of claim 1,
wherein the LEDs further includes a third LED in the sub-pixel,
wherein the sub-pixel further includes:
a third emission control transistor including a fourth gate electrode, a fourth source electrode connected to the first drain electrode, and a fourth drain electrode connected to an anode electrode of the third LED from among the LEDs, and
wherein the display driver circuitry is further configured to:
when the third LED does not have a manufacturing fault, in a third emission interval in the time interval subsequent to the second emission interval, provide a third emission signal to the fourth gate electrode to provide, using the driving transistor, the current to the third LED from among the LEDs, and
when the third LED has a manufacturing fault, in the third emission interval, forgo providing the third emission signal to the fourth gate electrode.

3. The electronic device of claim 2, wherein the display driver circuitry is further configured to:
when the third LED has a manufacturing fault, in the third emission interval, provide the first emission signal or the second emission signal to the second gate electrode or the third gate electrode to provide, using the driving transistor, the current to the first LED or the second LED from among the LEDs.

4. The electronic device of claim 1,
wherein the display panel includes another sub-pixel in another pixel different from a pixel including the sub-pixel,
wherein the other sub-pixel includes:
a plurality of LEDs including a third LED and a fourth LED,
another driving transistor including a fourth gate electrode configured to obtain another data voltage, a fourth drain electrode, and a fourth source electrode,
a third emission control transistor including a fifth gate electrode, a fifth source electrode connected to the fourth drain electrode, and a fifth drain electrode connected to the third LED from among the LEDs in the other sub-pixel, and
a fourth emission control transistor including a sixth gate electrode, a sixth source electrode connected to the fourth drain electrode, and a sixth drain electrode connected to the fourth LED from among the LEDS in the other sub-pixel, and
wherein the display driver circuitry is further configured to:
when the third LED from among the third and fourth LEDs has a manufacturing fault:
in the first emission interval, forgo providing a third emission signal to the fifth gate electrode, and
in the second emission interval, provide a fourth emission signal to the sixth gate electrode to provide, using the other driving transistor, another current according to the other data voltage to the fourth LED from among the LEDS in the other sub-pixel, and
when the fourth LED from among the third and fourth LEDs has a manufacturing fault:
in the first emission interval, provide the third emission signal to the fifth gate electrode to provide, using the other driving transistor, the other current to the third LED from among the LEDS in the other sub-pixel, and
in the second emission interval, forgo providing the fourth emission signal to the sixth gate electrode.

5. The electronic device of claim 4, wherein the display driver circuitry is further configured to:
when the third LED from among the third and fourth LEDs has a manufacturing fault, in the first emission interval, provide the fourth emission signal to the sixth gate electrode to provide, using the other driving transistor, the other current to the fourth LED from among the LEDs in the other sub-pixel; and
when the fourth LED from among the third and fourth LEDs has a manufacturing fault, in the second emission interval, provide the third emission signal to the fifth gate electrode to provide, using the other driving transistor, the other current to the third LED from among the LEDs in the other sub-pixel.

6. The electronic device of claim 4,
wherein the other current is a first current,
wherein the display driver circuitry is further configured to:
when both the third and fourth LEDs do not have a manufacturing fault:
in the first emission interval, provide the third emission signal to the fifth gate electrode to provide a second current to the third LED from among the LEDs in the other sub-pixel, and
in the second emission interval, provide the fourth emission signal to the sixth gate electrode to provide the second current to the fourth LED from among the LEDs in the other sub-pixel, and
wherein the first current provided when the third LED from among the third and fourth LEDs has a manufacturing fault or the fourth LED from among the third and fourth LEDs has a manufacturing fault is higher than the second current provided when both the third and fourth LEDs do not have a manufacturing fault.

7. The electronic device of claim 1,
wherein the sub-pixel further includes:
a capacitor connected to the first gate electrode,
a first operation control transistor including a fourth source electrode configured to obtain a driving voltage, a fourth gate electrode, and a fourth drain electrode connected to the first source electrode, and
a second operation control transistor including a fifth source electrode configured to obtain the driving voltage, a fifth gate electrode, and a fifth drain electrode connected to the first source electrode, and
wherein the display driver circuitry is further configured to:
in the first emission interval, provide the first emission signal to the fourth gate electrode, and
in the second emission interval, provide the second emission signal to the fifth gate electrode.

8. The electronic device of claim 1, wherein the display driver circuitry is further configured to:
for a first mode:
in the first emission interval, provide the first emission signal, and
in the second emission interval, provide the second emission signal; and
for a second mode displaying via the display panel an image with a power lower than a power consumed in accordance with displaying via the display panel an image based on the first mode:
in the first emission interval, provide the first emission signal, and
in the second emission interval, provide the first emission signal to the second gate electrode to provide the current to the first LED from among the LEDs using the driving transistor.

9. The electronic device of claim 1, wherein the display driver circuitry is further configured to:
for a first mode:
in the first emission interval, provide the first emission signal, and
in the second emission interval, provide the second emission signal; and
for a second mode displaying via the display panel an image with a power lower than a power consumed in accordance with displaying via the display panel an image based on the first mode:
in the first emission interval, provide the first emission signal, and
in the second emission interval, forgo respectively providing each of the first emission signal and the second emission signal to each of the second gate electrode and the third gate electrode.

10. The electronic device of claim 1,
wherein the display panel includes another sub-pixel in another pixel immediately below a pixel including the sub-pixel,
wherein the other sub-pixel includes:
a plurality of LEDs including the second LED shared with the sub-pixel, and a third LED,
another driving transistor including a fourth gate electrode configured to obtain another data voltage, a fourth drain electrode, and a fourth source electrode,
the second emission control transistor shared with the sub-pixel, and
a third emission control transistor including a fifth gate electrode, a fifth source electrode connected to the fourth drain electrode, and a fifth drain electrode connected to an anode electrode of the third LED,
wherein the third source electrode of the second emission control transistor is connectable to the first drain electrode or the fourth drain electrode, and
wherein the display driver circuitry is configured to:
in the first emission interval, provide the first emission signal to the second gate electrode based on a timing according to a position of the sub-pixel, for providing the current, using the driving transistor, to the first LED from among the LEDs in the sub-pixel,
in the first emission interval, while the third source electrode is connected to the fourth drain electrode from among the first and fourth drain electrodes, provide the second emission signal to the third gate electrode based on a timing according to a position of the other sub-pixel immediately positioned below the sub-pixel, for providing another current according to the other data voltage to the second LED from among the LEDs in the other sub-pixel using the other driving transistor,
in the second emission interval, while the third source electrode is connected to the first drain electrode from among the first and fourth drain electrodes, provide the second emission signal to the third gate electrode based on a timing according to the position of the sub-pixel, for providing the current, using the driving transistor, to the second LED from among the LEDs in the sub-pixel, and
in the second emission interval, provide a third emission signal to the fifth gate electrode based on a timing according to the position of the other sub-pixel, for providing the other current, using the other driving transistor, to the third LED from among the LEDs in the other sub-pixel.

11. The electronic device of claim 10,
wherein the sub-pixel includes a switch for connecting the third source electrode to the first drain electrode or the fourth drain electrode,
wherein the other sub-pixel includes the switch shared with the sub-pixel, and
wherein the display driver circuitry is configured to:
provide a second control signal to the switch to connect the third source electrode to the fourth drain electrode from among the first and fourth drain electrodes through the switch in the first emission interval, and
provide a first control signal to the switch to connect the third source electrode to the first drain electrode from among the first and fourth drain electrodes through the switch in the second emission interval.

12. The electronic device of claim 11,
wherein the first control signal is provided to the switch to connect the third source electrode to the first drain electrode and disconnect the third source electrode from the fourth drain electrode, and
wherein the second control signal is provided to the switch to connect the third source electrode to the fourth drain electrode and disconnect the third source electrode from the first drain electrode.

13. The electronic device of claim 10, wherein the display driver circuitry is configured to:
when the third LED does not have a manufacturing fault, in the second emission interval, provide the third emission signal to the fifth gate electrode, for providing the other current to the third LED; and
when the third LED has a manufacturing fault, in the second emission interval, forgo providing the third emission signal to the fifth gate electrode.

14. The electronic device of claim 1, wherein each of the LEDs has a size between about 10 micrometers and about 30 micrometers.

15. An electronic device comprising:
a display panel including sub-pixels,
wherein each of the sub-pixels includes:
a driving transistor including a gate electrode configured to obtain a data voltage, a source electrode configured to obtain a driving voltage, and a drain electrode, and
a plurality of light emitting diodes (LEDs) including:
a first LED including a first anode electrode connected to a node connectable to the drain electrode, and a first cathode,
a second LED including a second anode electrode connected to the first cathode, and a second cathode,
a third LED including a third anode electrode connected to the node and disconnected from the first cathode, and a third cathode, and
a fourth LED including a fourth anode electrode connected to the third cathode and disconnected from the first cathode, and a fourth cathode.

16. The electronic device of claim 15, comprising:
display driver circuitry configured to:
when the first LED from among the LEDs is short-circuited, control the second LED, the third LED, and the fourth LED to emit light according to the data voltage and the driving voltage, using the driving transistor,
when the second LED from among the LEDs is short-circuited, control the first LED, the third LED, and the fourth LED to emit light according to the data voltage and the driving voltage, using the driving transistor,
when the third LED from among the LEDs is short-circuited, control the first LED, the second LED, and the fourth LED to emit light according to the data voltage and the driving voltage, using the driving transistor,
when the fourth LED from among the LEDs is short-circuited, control the first LED, the second LED, and the third LED to emit light according to the data voltage and the driving voltage, using the driving transistor,
when the first LED and the third LED among the LEDs are short-circuited, control the second LED and the fourth LED to emit light according to the data voltage and the driving voltage, using the driving transistor,
when the first LED and the fourth LED from among the LEDs are short-circuited, control the second LED and the third LED to emit light according to the data voltage and the driving voltage, using the driving transistor,
when the second LED and the third LED from among the LEDs are short-circuited, control the first LED and the fourth LED to emit light according to the data voltage and the driving voltage, using the driving transistor, and
when the second LED and the fourth LED from among the LEDs are short-circuited, control the first LED and the third LED to emit light according to the data voltage and the driving voltage, using the driving transistor.

17. The electronic device of claim 16, wherein each of the sub-pixels includes an emission control transistor including:
another gate electrode configured to receive an emission signal from the display driver circuitry;
another source electrode connected to the drain electrode; and
another drain electrode connected to each of the first anode electrode and the third anode electrode through the node.

18. An electronic device comprising:
a display panel including sub-pixels,
wherein each of the sub-pixels includes:
a driving transistor including a gate electrode configured to obtain a data voltage, a source electrode configured to obtain a driving voltage, and a drain electrode, and
a plurality of light emitting diodes (LEDs) including:
a first LED including a first anode electrode connected to a node connectable to the drain electrode, and a first cathode,
a second LED including a second anode electrode connected to the first cathode, and a second cathode,
a third LED including a third anode electrode connected to the node and disconnected from the first cathode, and a third cathode connected to the first cathode and connected to the second anode electrode, and
a fourth LED including a fourth anode electrode connected to the third cathode, connected to the first cathode, and connected to the second anode electrode, and a fourth cathode.

19. The electronic device of claim 18, comprising:
display driver circuitry configured to:
when the first LED from among the LEDs is short-circuited, control the second LED and the fourth LED to emit light according to the data voltage and the driving voltage, using the driving transistor 1810,
when the second LED from among the LEDs is short-circuited, control the first LED and the third LED to emit light according to the data voltage and the driving voltage, using the driving transistor,
when the third LED from among the LEDs is short-circuited, control the second LED and the fourth LED to emit light according to the data voltage and the driving voltage, using the driving transistor,
when the fourth LED from among the LEDs is short-circuited, control the first LED and the third LED to emit light according to the data voltage and the driving voltage, using the driving transistor,
when the first LED and the third LED from among the LEDs are short-circuited, control the second LED and the fourth LED to emit light according to the data voltage and the driving voltage, using the driving transistor, and
when the second LED and the fourth LED from among the LEDs are short-circuited, control the first LED and the third LED to emit light according to the data voltage and the driving voltage, using the driving transistor.

20. The electronic device of claim 19, wherein each of the sub-pixels includes an emission control transistor including:
another gate electrode configured to receive an emission signal from the display driver circuitry;
another source electrode connected to the drain electrode; and
another drain electrode connected to each of the first anode electrode and the third anode electrode through the node.
